(19) United States
(12) Patent Application Publication
(10) Pub. No.: US 2024/0181671 A1
(43) Pub. Date: Jun. 6, 2024

(54) A PLASTIC COMPOSITE PRODUCT

(71) Applicant: NILO Global Limited, Auckland (NZ)

(72) Inventors: Simon David Oakley, Auckland (NZ); Thomas Clarence Hodgson, Millwater (NZ)

(21) Appl. No.: 17/784,037

(22) PCT Filed: Apr. 30, 2022
(86) PCT No.: PCT/IB2022/054015

§ 371 Date: Nov. 3, 2022

(30) Foreign Application Priority Data
Apr. 30, 2021 (AU) 2021901268

(51) Int. Cl. B27N 3/00; B27N 3/02; B27N 3/08; C08L 97/02

(52) U.S. Cl. CPC B27N 3/002; B27N 3/02; B27N 3/08; C08L 97/02; C08L 2205/025; C08L 2205/035; C08L 2205/16; C08L 2207/062; C08L 2207/066; C08L 2207/20; C08L 2312/00

(57) ABSTRACT

Described is a method for manufacturing a composite panel. The method broadly includes the steps of introducing a composite mixture into a press or mould, the composite mixture comprising about 4% to about 30% by weight of a binder that comprises a particularised plastic having a particle size of less than 4 mm, and the remainder being provided by a substrate. The composite mixture is then subjected to pressure sufficient to decrease the thickness of the composite mixture and is heated to about 100° ° C. to about 220° ° C. to form the wood composite panel.

### FIELD OF THE INVENTION

The present invention relates to a method for making a plastic composite product.

### BACKGROUND TO THE INVENTION

Plastic is a widely used material in both household and industrial items. Many countries are struggling to dispose or utilise the waste plastic in an economical and safe manner. The recycling of plastic into other goods is known, but requires energy and resources to wash the plastic, reduce it to a desired particle size from its original form and then re-utilise it in a recycled product.

It is an object of the present invention to provide a method for manufacturing a plastic composite product, or to at least provide the public with a useful choice.

### SUMMARY OF THE INVENTION

In a first aspect we describe a method of making a composite product, the method comprising combining a substrate and binder in a press or mould, subjecting the composite material to pressure sufficient to decrease the thickness of the composite mixture and heating the composite mixture to about 100° C. to about 220° C., the binder comprising about 0.1 to about 3% by weight of the binder of a crosslinking agent.

In a further aspect we describe a method for manufacturing a composite panel comprising
introducing a composite mixture into a press or mould, the composite mixture comprising
   about 4% to about 30% by weight of a binder that comprises particularised plastic having a particle size of less than 4 mm, and
   about 70 to about 96% by weight of a plurality of substrate,
   about 0.1 to about 3% by weight of the binder of a crosslinking agent,

subjecting the composite mixture to pressure sufficient to decrease the thickness of the composite mixture and heating the composite mixture to about 100° C. to about 220° C. to form the composite panel.

In a further aspect we describe a method for manufacturing a composite panel comprising
introducing a composite mixture into a press or mould, the composite mixture comprising
   about 4% to about 30% by weight of a binder that comprises particularised plastic having a particle size of less than 4 mm, and
   about 70 to about 96% by weight of a fibrous or particulate substrate,
   about 0.1 to about 3% by weight of the binder of a crosslinking agent,
subjecting the composite mixture to pressure sufficient to decrease the thickness of the composite mixture and heating the composite mixture to about 100° C. to about 220° C. to form the composite panel.

In a further aspect we describe a method for manufacturing a composite wood panel comprising
introducing a composite mixture into a press or mould, the composite mixture comprising
   about 4% to about 30% by weight of a binder that comprises particularised plastic having a particle size of less than 4 mm, and
   about 70 to about 96% by weight of a fibrous or particulate substrate,
   about 0.1 to about 3% by weight of the binder of a crosslinking agent,
subjecting the composite mixture to pressure sufficient to decrease the thickness of the composite mixture and heating the composite mixture to about 100° C. to about 220° C. to form the wood composite panel.

In a further aspect we describe a method for manufacturing a composite panel comprising
introducing a composite mixture into a press or mould, the composite mixture comprising
   about 4% to about 30% by weight of a binder that comprises particularised plastic having a particle size of less than 4 mm, and
   about 70 to about 96% by weight of a fibrous or particulate substrate,
   about 0.1 to about 3% by weight of the binder of a crosslinking agent,
subjecting the composite mixture to pressure of about 3 to about 10 MPa and heating the composite mixture to about 100° C. to about 220° C. to form the composite panel.

In a further aspect we describe a method for manufacturing a composite wood panel comprising
introducing a composite mixture into a press or mould, the composite mixture comprising
   about 4% to about 30% by weight of a binder that comprises particularised plastic having a particle size of less than 4 mm, and
   about 70 to about 96% by weight of a fibrous or particulate substrate,
   about 0.1 to about 3% by weight of the binder of a crosslinking agent,
subjecting the composite mixture to pressure of about 3 to about 10 MPa and heating the composite mixture to about 100° C. to about 220° ° C. to form the wood composite panel.

In a further aspect we describe a method for manufacturing a composite panel comprising
introducing a composite mixture into a press or mould, the composite mixture comprising at least a fine mixture and a coarse mixture at a ratio of about 20:80 to about 80:20,
   the fine mixture comprising
      particularised plastic having a particle size of less than 4 mm,
      a fibrous or particulate substrate having an average particle size of less than about 2 mm,
      about 0.1 to about 3% by weight of the particularised plastic of a crosslinking agent,
   the coarse mixture comprising
      particularised plastic having a particle size of less than 4 mm,
      a fibrous or particulate substrate wherein at least 80% of the particles have an average particle size of about 1 mm to about 15 mm,
      about 0.1 to about 3% by weight of the particularised plastic of a crosslinking agent,
subjecting the composite mixture to pressure sufficient to decrease the thickness of the composite mixture and heating the composite mixture to about 100° ° C. to about 220° C. to form the wood composite panel.

In a further aspect we describe a method for manufacturing a composite panel comprising
introducing a composite mixture into a press or mould, the composite mixture comprising
   a binder that comprises water and a particularised plastic having a particle size of less than 4 mm,
   a fibrous or particulate substrate, and
   about 0.1 to 3% by weight of the binder of a peroxide based cross-linker;
subjecting the composite mixture to pressure sufficient to decrease the thickness of the composite mixture and heating the composite mixture to about 100° C. to about 220° C. to form the wood composite panel.

In a further aspect we describe a method for manufacturing a composite panel comprising
combining a binder comprising water and a particularised plastic and a fibrous or particulate substrate within a press or mould,
   the plastic source comprising a mixture of
      low-melt particulate plastics having a particle size less than 4 mm and a melting point of 130° C. or less, and
      high-melt particulate plastics having a melting point greater than 130° C.,
   the fibrous or particulate substrate having a particle length of less than 15 mm
subjecting the composite mixture to pressure sufficient to decrease the thickness of the composite mixture and heating the composite mixture to about 100° C. to about 220° C. to form the wood composite panel.

In a further aspect we describe a plastic composite board comprising
4% to about 30% plastic by weight covalently or ionically bound to a fibrous or particulate substrate,

wherein the composite panel has a one or more of the following characteristics:
a) an MOE of about 1,000 to 4500 MPa,
b) an MOR of about 5 to about 25 MPa,
c) a surface screw holding of about 200 to about 500 N,
d) any combination of (a) to (c)

Any one or more of the following embodiments may relate to any of the aspects described herein or any combination thereof.

In one configuration at least 90% of the surface area of the substrate is coated by the plastic binder.

In one configuration the composite mixture in the press or mould is subjected to pressure of about 3, 4, 5, 6, 7, 8, 9 or about 10 MPa.

In one configuration the plastic has a particle size of less than 2 mm.

In one configuration the plastic particles have a sphericity of about 0.01 to 0.3 ψ, and suitable ranges may be selected from between any of these values.

In one configuration the plastic particles have a sphericity of about 0.40, 0.45, 0.50, 0.55, 0.60, 0.65, 0.70, 0.75, 0.80, 0.85, 0.90, 0.95 or 1.00 w, and suitable ranges may be selected from between any of these values.

In one configuration the plastic is selected from a polyethylene, polyvinyl chloride, polyethylene terephthalate or a polypropylene, or a combination thereof.

In one configuration the plastic is a combination of a high density polyethylene (HDPE) and a low density polyethylene (LDPE).

In one configuration the ratio of HDPE to LDPE is about 20:80 to about 80:20.

In one configuration the binder comprises 20, 30, 40, 50 or 60% solids content, and suitable ranges may be selected from between any of these values.

In one configuration the binder comprises water.

In one configuration the solids content of the binder comprises at least 80, 85, 90, 95, or 99% of a plastic, and suitable ranges may be selected from between any of these values.

In one embodiment the cross linker is a peroxide based cross-linker.

In one embodiment the substrate is selected from wood fibre, coconut husk, wood dust, sawdust, cellulosic material or a combination thereof.

In one configuration at least 80, 85, 90 or 95% of the fibrous or particulate substrate have an average particle size of about 1 mm to about 15 mm, and suitable ranges may be selected from between any of these values.

In one configuration the substrate is a wood substrate having a particle size of less than 10 mm, and/or a length of less than 50 mm.

In one configuration the panel comprises a combination of fine and course fibre.

In one configuration the panel comprises about 20:80 to about 80:20 of fine to course fibre.

In one configuration the substrate comprises at least 2, 3, 4, 5, 6, 7 or 8 sheets that are adhered to each other by the binder, and suitable ranges may be selected from between any of these values. In one configuration the sheets of substrate are formed from, or comprise, sheets of cellulosic material, such as wood.

In one configuration the substrate has a moisture content of less than 10%, less than 8%, or less than 6% by weight.

In one configuration the plastic source and substrate are placed into a mould to form a desired product end shape.

In one configuration the high melt plastic includes ABS or acrylic.

In one configuration the plastic source is selected from dissolvable and high-melt plastics, the dissolvable plastic comprising about 15% to about 85% by weight of the total amount of plastic substrate of PET, PVC, PC or a combination thereof, and the high-melt plastic being a slurry of plastic particles, having a particle size of less than about 2 mm, selected from acrylics, EVA, PVC, ABS, PE or a combination thereof.

In one configuration the curing agent is a peroxide based cross-linker.

In one configuration the binder comprises about 0.1 to about 3% by weight of the cross linker.

In one configuration the binder may include an accelerator.

In one configuration the accelerator is an amine based accelerator.

In one configuration the accelerator is a toluidine based accelerator.

In one configuration the accelerator is selected from N-(2-Hydroxylethyl)-N-Methyl-para-Toluidine, ethoxylated para-Toluidine, N, N-Dimethyl-p-Toluidine, N,N-Dihydroxyethyl-p-Toluidine, Diisopropoxy-p-Toluidine or a combination thereof.

In one configuration the binder is incrementally mixed with the fibrous or

particulate substrate.

In one configuration the composite mixture comprises 2 to 25% by weight

binder.

In one configuration the composite mixture comprises 2 to 20% by weight

binder.

In one configuration the composite mixture comprises 4 to 25% by weight binder.

In one configuration the composite mixture comprises 4 to 20% by weight binder.

In one configuration the ABS or acrylic comprises about 40 to about 60% by weight of the binder.

In one configuration the plastic source includes PVC.

In one configuration the plastic source comprises about 1 to about 5% by weight of the plastic source of PVC.

In one configuration the PVC increases the ductility of the plastic impregnated product.

In one configuration the wood-plastic composite product is selected from plywood, particle board, and medium density board.

In one configuration the composite material does not include any added formaldehyde.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7).

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

In this specification, where reference has been made to external sources of information, including patent specifications and other documents, this is generally for the purpose of providing a context for discussing the features of the present invention.

Unless stated otherwise, reference to such sources of information is not to be construed, in any jurisdiction, as an admission that such sources of information are prior art or form part of the common general knowledge in the art.

The term “comprising” as used in this specification means “consisting at least in part of”. When interpreting statements in this specification which include that term, the features, prefaced by that term in each statement, all need to be present but other features can also be present. Related terms such as “comprise” and “comprised” are to be interpreted in the same manner.

### BRIEF DESCRIPTION OF THE DRAWINGS

The invention will now be described by way of example only and with reference to the drawings in which:

FIG. 1 shows a view of a homogeniser set up having a pair of bodies, where the bodies are of a cylindrical form having a horizontal axis of rotation.

### DETAILED DESCRIPTION OF THE INVENTION

Described is a method for manufacturing a composite panel. The method broadly includes the steps of introducing a composite mixture into a press or mould, the composite mixture comprising about 4% to about 30% by weight of a binder that comprises a particularised plastic having a particle size of less than 4 mm, and the remainder being provided by a fibrous or particulate substrate. The composite mixture is then subjected to pressure sufficient to decrease the thickness of the composite mixture and is heated to about 100° C. to about 220° C. to form the wood composite panel.

As used herein, the term “slurry” refers to a mixture of a solid particle suspended in, or as part of a mixture containing a liquid. Preferably the slurry comprises about 10, 20, 30, 40, 50, or 60% solid particles. In some embodiments the slurry is a homogeneous dispersion of particles suspended in a liquid phase.

The term particle size in the specification is used to describe an average size of the particle and/or a maximum dimension of a particle. It will be appreciated that when the term particle size in reference to the size of a particle in the slurry, it may be that not every single particle in the slurry may have such a particle size, instead it may be a substantial amount of the particles.

The system, method and apparatus may be used for the processing a variety of input plastics.

Waste plastic provides a useful source of plastic for this process. In many countries waste plastic creates an environmental problem as society struggles to recycle or dispose of such plastic economically and safely. The sourced waste plastics may be for example the type of plastics derived from the waste recycling process. However, it will be appreciated various types of input plastic may be used depending on the desired output slurry.

The waste plastic can be a mixture of any of polyethylene terephthalate (PETE or PET), high-density polyethylene (HDPE), polyvinyl chloride (PVC), low-density polyethylene (LDPE), polypropylene (PP), polystyrene or styrofoam (PS), polycarbonate, polylactide, acrylic, acrylonitrile butadiene, styrene, fiberglass, rubber, paper and nylon. This waste plastic mixture may for example originate from a comingled plastic waste stream.

Given the wide use of plastic in society, the waste plastic is typically sourced from every-day waste products such as plastic bottles (e.g. milk, carbonated drinks, water bottles, cleaning products), plastic containers (e.g. for industrial products such as oil, food items), and packaging (whether rigid or soft), although it will be appreciated that the product list of waste products is immensely broad.

Waste plastic is typically categorised. For example, plastics are often stamped with a chasing arrows triangle encompassing an identifying number as shown below.

| Category | Plastic | Description of plastic products |
|---|---|---|
| [symbol] | Polyethylene | Soft drink bottles, mineral juice, fruit |
| PETE | terephthalate | juice container, cooking oil |
| [symbol] | High density | Milk jugs, cleaning agents, laundry |
| HDPE | polyethylene | determents, bleaching agents, shampoo |
| | | bottles, washing and shower soaps |
| [symbol] | Polyvinyl chloride | Trays for sweets, fruit, plastic packaging |
| PVC | | (bubble foil) and food foils to wrap the |
| | | foodstuff. |
| [symbol] | Low-density | Crushed bottles, shopping bags, highly- |
| LOPE | polyethylene | resistant sacks and most of the |
| | | wrappings |
| [symbol] | Polypropylene | Furniture, consumers luggage, toys, as |
| PP | | well as bumpers, lining and external |
| | | borders of cars, yoghurt and margarine |
| | | tubs |
| [symbol] | Polystyrene | Toys, hard packing, refrigerator trays, |
| PS | | cosmetic bags, costume jewellery, CD |
| | | cases, vending cups |
| [symbol] | Acrylic, | Large water bottles, some juice bottles |
| OTHER | polycarbonate, | |
| | polyactic fibres, | |
| | nylon, fibreglass | |

One source of plastic may be shredded plastic. Shredded plastic may be shredded to a particle size of less than about 20 mm.

Plastic particles may be measured by direct imaging using light microscopy. Samples may first be analysed by laser diffraction technique using a CILAS 1180, to have a general idea of the particle size distribution. A suspension of plastic may be placed in a Sedgewick Rafter cell (SRC) etched with a 50 column by 20 row grid. Size and particle count measurements may be determined at 100× and 200× magnifications with an Olympus BX 51 calibrated eyepiece binocular microscope with QCapture Pro 5.1 imaging software. For each sample three replicates may be used and the longest length of the first 100 particles in 6 randomly selected transects measured. To determine particle size distribution, 300 particles from each sample may be measured. The lengths may be manually determined with an ocular calibrated micrometer and the values were converted to microns or mm.

The shredded plastic has a particle size of about 2, 3, 4, 5, 6, 7, 8, 9, 10, 11, 12, 13, 14, 15, 16, 17, 18, 19 or 20 mm, and suitable ranges may be selected from between any of these values, (for example, about 2 to about 20, about 2 to about 18, about 2 to about 15, about 2 to about 10, about 2 to about 8, about 3 to about 20, about 3 to about 17, about 3 to about 16, about 3 to about 12, about 3 to about 10, about 3 to about 7, about 4 to about 20, about 4 to about 18, about 4 to about 14, about 4 to about 10, about 4 to about 8, about 5 to about 20, about 5 to about 19, about 5 to about 15, about 5 to about 10, about 6 to about 20, about 6 to about 17, about 6 to about 13, about 6 to about 10, about 7 to about 20, about 7 to about 18, about 7 to about 16, about 7 to about 10, about 8 to about 20, about 8 to about 18, about 8 to about 15, about 8 to about 10, about 9 to about 20, about 9 to about 16, about 9 to about 14, about 10 to about 20, about 10 to about 17, about 11 to about 20, about 11 to about 17, about 12 to about 20, about 12 to about 18 or about 13 to about 20 mm).

Various methods are known to reduce the original plastic products to a particle size as described above. For example, the use of cutting and/or extruders, shredders, granulators or grinders. Cutting and extruding machines (e.g. see U.S. Pat. No. 9,744,689) can include one or more knives that rotate in a housing such that any plastic introduced into the housing is cut by the knives into smaller particles. In some machines the plastic may start to melt, or melt, due to the action of the knives (i.e. by the heat produced by friction) and such melted or partially melted plastic may enter an extruder in which the screws carry the plastic away from the cutting blades. The plastic may then be extruded and cut into small pallets at the outlet of the extruder.

Shredders (e.g. see U.S. Pat. No. 6,241,170), granulators (e.g. see U.S. Pat. No. 6,749,138) and grinders (e.g. see U.S. Pat. No. 5,547,136 or German patent DE 19614030 A1) may include a single or plurality of cutting wheels or rollers that again rotate in a housing and reduce the size of the plastic through the action of the cutting wheel or rollers against the plastic as the plastic passes between the cutting wheels or roller and the internal surface of the housing. Alternately, the plastic may pass between two or more banks of knives or rollers, that in some cases overlap, such that the plastic is cut or ground due to this passage.

Such processes typically use rotary knives or bed knives whose rotation cuts the plastic into smaller particles or pieces.

The shredded plastic is then reduced further in size to an average particle size of less than about 4 mm. The plastic may have an average particle size of less than about 1, 2, 3 or 4 mm, and suitable ranges may be selected from between any of these values, (for example, about 1 to about 4, about 1 to about 3, about 1 to about 2, about to about 4, about 2 to about 3 mm).

An example of a size reducing apparatus to achieve the above is the use of a macerator having two or more cylindrical bodies that rotate relative to each other. This is described in Section 4 below.

The emulsion produced may be a plastic suspended in the carrier. The carrier is preferably water. In some configurations the plastic emulsion (that is, the binder) may comprise 20, 25, 30, 35, 40, 45, 50, 55, 60, 65, 70, 76, or 80% by weight solids content (of plastic).

The binder may be formed from a polyester-based thermoplastic polymer resin such as polyethylene terephthalate (PET). The propylene-based thermoplastic polymer may be polypropylene (PP). The homo-polymer of an alkene may be a homo-polymer of ethylene. The homo-polymer of ethylene may be polyethylene (PE)(including high and low density polyethylene).

### 1.1 Crosslinker

A cross linking agent is one that links one polymer chain to another. The links may be covalent or ionic bonds. Cross linking of thermoplastics is part of the curing process since when polymer chains are cross linked, the material becomes more rigid.

While cross linking can be initiated by heat, pressure, change in pH or irradiation, the cross linking agent as used herein refers to a chemical that results in a chemical reaction that forms cross links. That is not to exclude that cross linking may also occur due to the heat and pressure used in the current process.

In one configuration the cross linking agent may be a peroxide-based cross linker. In some configurations the peroxide can be selected from inorganic peroxides, diacyl peroxides, peroxyesters, peroxydicarbonates, dialkyl peroxides, ketone peroxides, peroxyketals, cyclic peroxides, peroxymonocarbonates, hydroperoxides, dicumyl peroxide, benzoyl peroxide, 2,5-Di(tert-butylperoxy)-2,5-dimethyl-3-hexyne, 3,3,5,7,7-pentamethyl 1,2,4-trioxepane, dilauryl peroxide, methyl ether ketone peroxide, t-amyl peroxyacetate, t-butyl hydroperoxide, t-amyl peroxybenzoate, D-t-amyl peroxide, 2,5-Dimethyl 2,5-Di(t-butylperoxy)hexane, t-butylperoxy isopropyl carbonate, succinic acid peroxide, cumene hydroperoxide, 2,4-pentanedione peroxide, t-butyl perbenzoate, diethyl ether peroxide, acetone peroxide, arachidonic acid 5-hydroperoxide, carbamide peroxide, tert-butyl hydroperoxide, t-butyl peroctoate, t-butyl cumyl peroxide, Di-sec-butyl-peroxydicarbonate, D-2-ethylhexylperoxydicarbonate, 1,1-Di(t-butylperoxy)cyclohexane, 1,1-Di(tert-butylperoxy)-3,3,5-trimethylcyclohexane, 2,5-Dimethyl-2,5-di(tert-butylperoxy)hexane, 3,3,5,7,7-Pentamethyl-1,2,4-trioxepane, Butyl 4,4-di(tert-butylperoxy)valerate, Di(2,4-dichlorobenzoyl) peroxide, Di(4-methylbenzoyl) peroxide, Di(tert-butylperoxyisopropyl)benzene, tert-Butyl cumyl peroxide, tert-Butyl peroxy-3,5,5-trimethylhexanoate, tert-Butyl peroxybenzoate, tert-Butyl peroxy 2-ethylhexyl carbonate, and mixtures thereof.

In one configuration the cross linker maybe a silane cross-linking agent. The silane cross-linker may be selected from an acetoxy silane crosslinker, an oximino silane based crosslinker, a methylethylketoxime (MEKO) based crosslinker, a methylisobutylketoxime (MIBKO) based crosslinker, an acetoxime based crosslinker, an alkoxy silane based crosslinker, or a combination thereof. In some examples, the crosslinker includes a methyl tris(MEKO)silane, a tetra(MEKO)silane, a vinyl tris(MEKO)silane, a methylvinyl di(MEKO)silane, a phenyl tris(MEKO) silane, a methyl tris(MIBKO)silane, a tetra(MIBKO)silane, a vinyl tris(MIBKO)silane, a methyl tris(acetoxime)silane, a vinyl tris(acetoxime)silane, or a mixture thereof.

The cross linker is added to the plastic binder in an about of about 0.1, 0.5, 1, 1.5, 2.0, 2.5 or 3% by weight of the binder, and suitable ranges may be selected from between any of these values (for example, about 0.1 to about 3, about 0.1 to about 2.5, about 0.1 to about 2, about 0.1 to about 1, about 0.5 to about 3, about 0.5 to about 2, about 0.5 to about 1, about 1 to about 3, about 1 to about 2.5, about 1 to about 2. 1.5 to about 3 or about 2 to about 3% by weight of the binder).

In some configurations the plastic used in the binder may be a virgin plastic. In such embodiments the cross linker facilitates the thermosetting process for plastic products.

### 1.2 Substrate

The substrate may be selected from a range of matter being cellulosic such as wood (such as sawdust, wood fibre, wood particles, wood chips or wood sheets), coconut husk, paper, cardboard; or construction material such as concrete particles, or glass, or a combination thereof. The selection of the substrate will define the nature and use of the composite material product. For example, the use of wood-based substrate will produce a wood-plastic composite product, whereas the use of concrete substrate will produce a concrete-plastic composite product.

For plywood and glulam style wood products, the wood may be in the form of sheets, that are glued to one another through the use of the binder. In this case the sheets of wood may have at least one dimension that is greater than about 1 m in length.

For other products, such as oriented strand board, wafer board, particle board, softboard, MDF or hardboard, the wood-based substrates may have at least one dimension (such as the major dimension) less than 500 mm in length. For example an oriented strand board may comprise a wood-based substrate in which the major dimension is between about 50 mm to about 500 mm. A wafer board may comprise a wood-based substrate in which the major dimension is between about 10 mm to about 50 mm. A particle board may comprise a wood-based substrate in which the major dimension is between about 1 mm to about 15 mm. Softboard, MDF and hardboard may comprise a wood-based substrate in which the major dimension is between about 1 mm and 5 mm.

In relation to wood-based substrates, the substrate may be sourced from a range of different wood-based products. For example, a fine grade of wood-based substrate may have an average particle size of about 0.5, 1, 1.5, or 2 mm, and suitable ranges may be selected from between any of these values (for example, about 0.5 to about 2, about 0.5 to about 1.5, about 0.5 to about 1, about 1 to about 2, about 1 to about 1.5 or about 1.5 to about 2 mm). For example, the fine grade of wood-based substrate may be sourced from sawdust, or wood flour. It will be appreciated that any source that results in a wood-based substrate having an average particle size as defined above may be appropriate for use. For example, the use of grinding such as the use of a hammer mill. A grinder system may control the size of the particles produced through the use of grinder screens, which are screens having a mesh with set perforation sizes.

The wood-based substrate may be a coarser grade of substrate having an average particle size of about 1, 2, 3, 4, 5, 6, 7, 8, 9, 10, 11, 12, 13, 14 or 15 mm, and suitable ranges may be selected from between any of these values (for example, about 1 to about 15, about 1 to about 13, about 1 to about 10, about 1 to about 8, about 1 to about 5, about 2 to about 15, about 2 to about 14, about 2 to about 10, about 2 to about 6, about 3 to about 15, about 3 to about 12, about 3 to about 9, about 4 to about 15, about 4 to about 11, about 4 to about 8, about 5 to about 15, about 5 to about 13, about 5 to about 10, about 6 to about 15, about 6 to about 12, about 6 to about 10, about 6 to about 8, about 7 to about 15, about 7 to about 11, about 8 to about 15, about 8 to about 13, about 9 to about 15, about 9 to about 12 or about 10 to about 15 mm). For example, the coarser grade of wood-based substrate may be sourced from wood chips and wood pellets.

When defining the size of the wood particles as the “average particle size” it will be appreciated that wood particles are not uniform in size. Given wood particles are often irregular in shape the average particle size refers to the length of the longest axis.

A conventional method to obtain the particle size distribution is mechanical sieving. American Society of Agricultural and Biological Engineers (ASABE Standard S424.1, 2007) developed the mechanical sieving method as a standard particle size analysis for biomass particles. Mechanical sieving determines the mass percent of particles retaining on each sieve. However, since particles pass through the sieves based on their width the length of the particles is ignored in a sieving process. Given the particles may be mostly irregular and heterogeneous in size and shape two particles that pass through the same sieve may have different shapes.

Rather than the conventional mechanical sieving approach, advanced techniques such as machine vision are able to analyse particle size and shape using image analysis techniques. Image analysis is a practical method to determine the actual dimensions and shape of single particles. Image analysis is not subjective and is repeatable over the same picture.

Another method to characterise the size of wood particles may be to look at the bulk density of a product. Smaller particles will rearrange themselves to a more efficient packing condition thus having a higher bulk density. For example, the bulk density of wood sawdust is about 370 kg/m³ to about 415 kg/m³.

In relation to construction grade material such as concrete, measurement by sieves and the use of sedimentation systems have been common in the cement industry but the use of light scattering instruments provides good accuracy. In relation to sieving, a fine grade of construction material particles may pass through a 35 mesh (0.5 mm) to 10 mesh (2 mm opening). In relation to a coarse construction grade material such as concrete the material may be sized between 18 mesh (1 mm) to 5/18 in mesh (16 mm). That is, material that can pass through the 5/18 in mesh, and material that is retained by the 18 mesh.

As discussed above, the plastic may be size reduced through the use of a homogeniser. The shredded plastic may first be introduced into a vat with an agitator. The agitator may receive solid material (such as plastic) having a particle size of about 5, 6, 7, 8, 9, 10, 11, 12, 13, 14, 15, 16, 17, 18, 19 or 20 mm, and suitable ranges may be selected from between any of these values (for example, about 5 to about 20, about 5 to about 18, about 5 to about 14, about 5 to about 10, about 5 to about 8, about 6 to about 20, about 6 to about 17, about 6 to about 15, about 6 to about 10, about 6 to about 8, about 7 to about 20, about 7 to about 18, about 7 to about 15, about 7 to about 12, about 7 to about 9, about 8 to about 20, about 8 to about 18, about 8 to about 16, about 8 to about 15, about 8 to about 13, about 8 to about 12, about 9 to about 20, about 9 to about 15, about 9 to about 13, about 10 to about 20, about 10 to about 16, about 10 to about 14, about 11 to about 20, about 11 to about 18, about 11 to about 15, about 12 to about 20, about 12 to about 17, about 12 to about 15, about 13 to about 20, about 13 to about 19, about 13 to about 16 or about 14 to about 20 mm).

The agitator may receive material having a homogenous or semi-homogenous particle size. For example, the agitator may receive material having a particle size of approximately 8 mm. In another embodiment the particle size of the material has a size distribution whereby at least 90, 91, 92, 93, 94 or 95% of the material has a mean particle diameter of 5, 6, 7, 8, 9, 10, or 11 mm, and suitable ranges may be selected from between any of these values (for example, about 5 to about 11, about 5 to about 9, about 5 to about 8, about 6 to about 11, about 6 to about 10, about 6 to about 8, about 7 to about 11, about 7 to about 10, about 7 to about 8 or about 8 to about 11 mm).

The particle size of the input material may have a particle size distribution whereby at least 90% of the particles have a diameter of about 5, 6, 7, 8, 9, 10 or 11 mm. In one embodiment, the invention relates to a population of material particles wherein at least 90% of the particles have a diameter within 1 mm of the mean diameter of the population.

The agitator may be in the form of a vessel or tank that includes a stirrer having at least one blade on its end. A system inlet slurry may be provided to an inlet of the agitation stage, and an outlet of the agitation stage provides the agitated slurry to the maceration stage.

The agitator stage may comprises a vessel comprising a stirrer. The stirrer may be configured to agitate the system inlet slurry within the vessel to produce agitated slurry. Preferably the stirrer creates a vortex within the vessel. Without wishing to be restrained by theory, the vortex assists in keeping the waste plastic particles suspended in the vessel, to prevent the waste plastic from settling at the bottom of the vessel.

Alternatively, where the density of the waste plastic is less than the density of the carrier liquid, the plastic may at least partially float within the vessel. In such a configuration, the stirrer may preferably create a vortex or flow within the vessel to draw the plastic from floating in the vessel downwards to an outlet of the vessel to the macerator.

The stirrer may create a homogeneous mix of plastic and solvent such as water within the vessel.

The stirrer of the agitator may operate at a rotational rate that achieves substantial homogeneity of the material within the slurry. By “substantial”, this means at least 70, 75, 80, 85, 90 or 95% homogeneity. Without wishing to be bound by theory, this degree of homogeneity is sufficient to achieve the desired input feed rate of the material to the macerator 10, without the macerator jamming. For example, the stirrer may be operated at speeds of approximately 100 RPM to approximately 5,000 RPM.

In some forms, the stirrer may increase in operational speed over the processing of a fixed quantity of plastic from the vessel. For example, if the mass or volume of plastic relative to the volume of solvent in the vessel decreases over the operation of the process, the operational speed of the of the stirrer may be increased in order to maintain a constant, or substantially constant, flow rate of plastic from the outlet of the vessel and to the macerator 10. For example, the stirrer 62 may begin at approximately 2,000 RPM, and be increased to approximately 5,000 RPM by the end of processing of a fixed quantity of plastic from the agitator.

In addition or alternative, in some forms the operational speed of the stirrer 62 may be controlled dependent on the size, or average size, of the plastic particles within the vessel.

In some embodiments the agitator comprises one or more baffles, the one of more baffles extending from an inner wall of the vessel. Without wishing to be bound by theory, the baffles may act to retain the plastic particles to the centre of the vessel.

The stirrer may act to further reduce the particle size of the plastic.

In some embodiments a plate is located above the stirrer blade. The plate may have a diameter about equal to the diameter of the stirrer blades. Preferably the diameter of the blade is 80, 95, 90, 95, 100, 105, 110, 115 or 120% the diameter of the stirrer blade, and suitable ranges may be selected from between any of these values.

In some embodiments the waste plastic from the outlet of the agitation stage has a particle size of 0.5, 1.0, 1.5, 2.0, 2.5, 3.0, 3.5 or 4.0 mm, and suitable ranges may be selected from between any of these values, (for example, about 0.5 to about 4.0, about 0.5 to about 3.0, about 0.5 to about 2.5, about 0.5 to about 1.5, about 1.0 to about 4.0, about 1.0 to about 3.5, about 1.0 to about 2.5, about 1.5 to about 4.0, about 1.5 to about 3.5, about 1.5 to about 2.5, about 2.0 to about 4.0, about 2.0 to about 3.5, about 2.0 to about 3.0, about 2.5 to about 4.0, about 2.5 to about 3.5, about 2.5 to about 3.0, or about 3.0 to about 4.0 mm).

The plastic enters the inlet of the agitator as a slurry as described. The liquid, that forms the slurry with the plastic particles, can be water.

In some embodiments the agitator is run as a continuous process, with the slurry exiting the outlet of the agitator with plastic particles that have reached a particle size of less than 0.5, 1.0, 1.5, 2.0, 2.5, 3.0, 3.5 or 4.0 mm, and suitable ranges may be selected from between any of these values, (for example, about 0.5 to about 4.0, about 0.5 to about 3.0, about 0.5 to about 2.5, about 0.5 to about 1.5, about 1.0 to about 4.0, about 1.0 to about 3.5, about 1.0 to about 2.5, about 1.5 to about 4.0, about 1.5 to about 3.5, about 1.5 to about 2.5, about 2.0 to about 4.0, about 2.0 to about 3.5, about 2.0 to about 3.0, about 2.5 to about 4.0, about 2.5 to about 3.5, about 2.5 to about 3.0, or about 3.0 to about 4.0 mm).

This particle size selection can be achieved through the use of a particle size selector on the outlet pipe, such as a mesh having a mesh size that allows plastic particles below a desired size through. The stirrer acts to prevent build-up of larger-sized plastic particles about the size selector at the outlet.

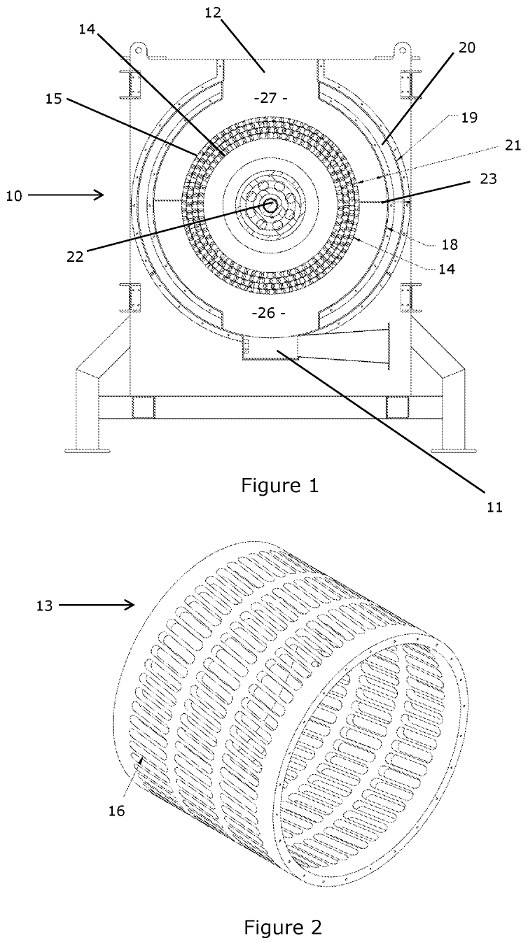

The plastic particles may then pass to a macerator as shown in FIG. 1. The macerator may form part of the system or method as described herein. The macerator 10 may comprise an inlet 11 configured to receive a flow of inlet slurry comprising plastic particles. The macerator 10 may also comprise an outlet 12 configured to provide the outlet slurry from the macerator 10.

The macerator 10 comprises a housing 17. The housing may comprise an inner casing 18 and an outer casing 19 that defines an intermediate space 20. The inner casing may comprise a plurality of apertures or slots that allow the slurry to be fluidly connected between the gap area (i.e. the volume of space between the outer body 13 and the inner surface of the housing 17) or the inner casing 19. The inner casing 18 may be, or comprise, wedge wire. The size of any slot, aperture or wedge wire may be such that it substantially prevents any plastic from the slurry from entering the intermediate space 20.

The width of the intermediate space will depend on the size of the masticator. To provide guidance, for a masticator with an outer body diameter of about 1.8 m the gap may be about 200 to about 300 mm. For the same size masticator the intermediate space may be about 100 to 150 mm wide.

The masticator may comprise baffles that extend in a direction along the axis of rotation, that is, from the front to the rear of the masticator body. The baffles may be positioned to separate the gap space into two portions. In one embodiment the baffles may be positioned so that they are about level with the axis of rotation. That is, such positioning would separate the chamber into two substantially equal hemispheres.

The macerator may comprise a vacuum pump that applies a vacuum to the chamber outlet. The vacuum pump may achieve a head pressure at the outlet of about 2.5, 3.0, 3.5, 4.0, 4.5, 5.0, 5.5, 6.0, 6.5, 7.0, 7.5, 8.0, 8.5, 9.0, 9.5 or 10 psi, and suitable ranges may be selected from between any of these values, (for example about 2.5 to about 10.0, about 2.5 to about 8.5, about 2.5 to about 4.5, about 3.0 to about 10.0, about 3.0 to about 7.0, about 4.0 to about 10.0, about 4.0 to about 8.5, about 4.0 to about 6.0, about 4.5 to about 10.0, about 4.5 to about 8.5, about 5.0 to about 10.0, about 5.0 to about 8.0, about 5.5 to about 10.0, about 5.5 to about 9.0 or about 6.0 to about 10.0 psi). The vacuum pump is preferably an impeller pump.

The plastic may be injected into the chamber via a screw that receives the plastic from a hopper 24. A liquid may be pumped into the chamber to mix with the plastic to create the slurry.

The macerator comprises the one or more injectors that assist or direct the flow of slurry through the apertures of the bodies. That is, the plastic particles may collect near the baffles or substantially bypass the apertures of the bodies. The liquid injection assists in directing the plastic through the apertures of the bodies.

In one embodiment the injectors may inject liquid into the first portion 26 adjacent to, or proximal to, the baffle. That is, the injector may have an outlet that is proximal to, or adjacent the baffle. The injectors may inject a low volume but high pressure stream of liquid to force the plastics through the apertures of the bodies and prevent collecting of the plastic particles near the baffle.

The macerator may comprise a plurality of injectors that inject liquid (i.e. water or organic solvent) into the gap proximal and distally to the baffle.

The macerator may also include one or more injectors that inject liquid into the gap in the second portion. Preferably the injection is at a location in the second portion 27 adjacent or proximal to the baffle.

In one configuration the pressure of the liquid injected from the injectors proximal to the baffle is greater than the pressure of liquid injected by the injectors located distally to the baffle. That is, there may be a gradient of pressure that is greatest closest to the baffle that decrease as the injector outlet is located distally to the baffle.

In one embodiment the entire intermediate area may be pressurised so that there is water directed about a substantial part of the surface area of the inner casing.

The injector may be a pump that comprises a conduit and outlet to the conduit that vents into the gap 21 or the intermediate space 20.

In one configuration the outlet conduit of the pump may traverse the outer casing so that the outlet injects liquid into the intermediate space 20 (if present) or the gap 21.

The pump is preferably an impeller pump. The pump is preferably a 300 psi multistage impeller pump.

In one embodiment the injector provide jets of liquid at high pressure. That is, the volume of water may be quite low, but the pressure is high as the jet is quite constrained in terms of its diameter. The pumps may provide a steady rate of flow. Alternately the pumps may provide a variable rate of flow. For example, the pumps may provide a flow of liquid at a first pressure and then a flow of liquid at, at least, a second pressure. The pumps may provide a pulsatile flow of liquid. That is, the pumps may provide a jet of liquid for a set period of time, and then no flow of a period of time; after which the pattern is repeated.

Any number of pumps may be arrayed about the housing of the masticator, each pump having an outlet into the gap or the intermediate space.

The intermediate space may be isolated from the gap space so that plastic containing slurry is not able to access the intermediate space. This may be achieved by the aperture or slot size of the inner casing being smaller than the plastic particle size.

The pressure in the intermediate space may be at least 2.5, 3. 3.5, 4.0, 4.5, 5.0, 5.5, 6.0, 6.5, 7.0, 7.5 or 8 times the pressure of the slurry in the gap, and suitable ranges may be selected from between any of these values, (for example, about 2.5 to about 8.0, about 2.5 to about 7.0, about 2.5 to about 6.0, about 2.5 to about 5.0, about 3.0 to about 8.0, about 3.0 to about 7.5, about 3.0 to about 6.0, about 3.5 to about 8.0, about 3.5 to about 7.0, about 3.5 to about 6.5, about 4.0 to about 8.0, about 4.0 to about 7.0, about 4.0 to about 6.0, about 5.0 to about 8.0, about 5.0 to about 6.5, about 5.5 to about 8.0, about 5.5 to about 7.5 or about 6.0 to about 8.0 times the pressure of the slurry in the gap).

The temperature of the slurry may be less than about 30, 25, 20, 15, or 10° C., and suitable ranges may be selected from between any of these values, (for example, about 10 to about 30, about 10 to about 25, about 10 to about 20, about 15 to about 30, about 15 to about 25, about 15 to about 20 or about 20 to about 30° C.). In one configuration the injected liquid is chilled. In one embodiment the injected liquid is water.

The pressure in the chamber may be about 3, 4, 5, 6, 7, 8, 9, 10, 11, 12, 13, 14 or 15 psi, and suitable ranges may be selected from between any of these values, (for example, about 3 to about 15, about 3 to about 13, about 3 to about 10, about 3 to about 8, about 4 to about 15, about 4 to about 12, about 4 to about 8, about 5 to about 15, about 5 to about 12, about 5 to about 10, about 6 to about 15, about 6 to about 13, about 6 to about 10, about 6 to about 8, about 7 to about 15, about 7 to about 12, about 7 to about 10, about 8 to about 15, about 8 to about 13, about 8 to about 10, about 9 to about 15, about 9 to about 13, about 10 to about 15 psi).

The macerator may comprise 2, 3, 4, 5, 6, 7 or 8 bodies, and suitable ranges may be selected from between any of these values. In one configuration each body rotates a direction opposite to an adjacent body. An exception to this is that the inner or outermost bodies may be static (i.e. do not rotate).

The bodies may comprise a shield 25 at the first and second end to enclose the bodies, and ensure that the slurry has to traverse as many of the apertures of the bodies as possible. For example, since plastic floats, ideally this provides direction for the plastic (assisted by the vacuum pressure at the outlet) for the plastic (for example in the case of a two body masticator) to be cut four times. i.e. once through the outer body, then inner body then the inner body on the second portion side of the chamber and the outer body and then out the outlet.

The process may reduce the particle size between the chamber inlet and chamber outlet by at least 40, 45, 50, 55, 60, 65, 70, 75, 80, 85, 90, 95%, and suitable ranges may be selected from between any of these values.

The process may produce particles having a mean particle size of less than 20, 19, 18, 17, 16, 15, 14, 13, 12, 11, 10, 9, 8, 7, 6, 5, 4, 3, 2, 1 or 0.5 mm, and suitable ranges may be selected from between any of these values.

The process may produce particles having a mean particle size of less than 20, 19, 18, 17, 16, 15, 14, 13, 12, 11, 10, 9, 8, 7, 6, 5, 4, 3, 2, or 1 μm, and suitable ranges may be selected from between any of these values.

In one configuration the outlet is configured to provide a flow of outlet slurry comprising plastic particles having a particle size being less than the particle size of the plastic particles of the inlet slurry.

The macerator 10 may comprise two or more bodies 13, either as a pair of bodies, or a plurality of bodies in stacked relationship. The bodies 13 therefore comprise at least an inner body 14 and an outer body 15. Each adjacent body such as an inner body 14 and an outer body 15 rotate relative to each other. For example, one body may be fixed, and the adjacent body rotate, or both bodies may rotate in an opposite directions to each other.

As shown in FIG. 1 is a macerator comprising four bodies being from an inner body 14 to an outer body 15. The plastic is inlet at 11 and outlets at 12. The relative motion is provided by the bodies rotating relative to each other. For example, the outer most body may remain static, that is, it does not rotate. The second body may then rotate, for example, anti-clockwise. The successive body may then rotate clockwise and so forth. Alternately, the inner body may be static with successive outer bodies rotating.

In one embodiment an inner body 14 and an outer body 15 may rotate relative to each other at a rotational speed of about 100, 150, 200, 250, 300, 350, 400, 450, 500, 550, 600, 650, 700, 750, 800, 850, 900, 950 or 1,000 RPM, and suitable ranges may be selected from between any of these values, (for example, about 100 to about 1000, about 100 to about 900, about 100 to about 700, about 100 to about 600, about 100 to about 500, about 200 to about 1000, about 200 to about 800, about 200 to about 700, about 200 to about 600, about 200 to about 500, about 200 to about 400, about 300 to about 1000, about 300 to about 900, about 300 to about 700, about 300 to about 600, about 300 to about 500, about 300 to about 400, about 400 to about 1000, about 400 to about 700, about 400 to about 600, about 400 to about 500, about 500 to about 1000, about 500 to about 900, about 500 to about 700, about 500 to about 600, about 600 to about 1000, or about 600 to about 700 RPM).

More preferably, an inner body 14 and an outer body 15 may rotate relative to each other at a rotational speed of about 500, 520, 540, 560, 580, 600, 620, 640, 660, 680 or 700 RPM, and suitable ranges may be selected from between any of these values, (for example, about 500 to about 700, about 500 to about 660, about 500 to about 600, about 520 to about 700, about 520 to about 640, about 540 to about 700, about 540 to about 660, about 540 to about 600, about 560 to about 700, about 560 to about 660, about 560 to about 620, about 580 to about 700, about 580 to about 660, about 580 to about 620, about 600 to about 700, about 600 to about 680, about 600 to about 640, about 620 to about 700, about 620 to about 680, about 640 to about 700 RPM).

The speed of relative rotation of the inner body 14 and outer body 15 may be provided dependent on one or more other variables, such as for example the feed rate of plastic and carrier solvent to the macerator 10, the proportion of plastic to carrier solvent in the inlet feed, the type of carrier solvent, the maximum particle size of inlet plastic, the average particle size of inlet plastic, the dimensions of the macerator 10 relative to a) the inlet particle size, b) the inlet plastic and/or carrier flow rate, c) the dimensions of the inlet conduit to the macerator, and/or d) the type or types of inlet plastic. It may also be dependent on, either separately or in addition, the dimensions or other characteristics of the agitator, the fill level of the agitator, the relative proportions of plastic and solvent in the agitator, and the agitator RPM rate.

As shown in FIG. 2 the slot or apertures 16 in the bodies provide elongate sections having a leading and trailing edge.

In one embodiment the leading edge and trailing edge of the elongate sections of the body are positioned parallel to the notional circumference of the rotational axis of the body.

The leading edge of the elongate sections of the body may be positioned at an angle to the notional circumference of the rotational axis of the body. Preferably the leading edge is positioned at an angle of about 5, 10, 15, 20, 25 or 30 degrees relative to the notional circumference of the rotational axis of the body, and suitable ranges may be selected from between any of these values, (for example, about 5 to about 30, about 5 to about 25, about 5 to about 20, about 5 to about 15, about 10 to about 40, about 10 to about 20, about 10 to about 15, about 15 to about 30, about 15 to about 25 or about 20 to about 30 degrees).

Each body (inner body 14 and the outer body 15) may have at least one or a plurality of apertures 16. The apertures 16 extend through the respective body. The apertures 16 define a flow path through each body.

The inlet slurry may traverse the flow path from the macerator inlet 17 to the macerator outlet 18 via the at least one aperture 16 of each body to produce an outlet slurry.

In some embodiments, the macerator 10 may comprise one or more inlets 11. The macerator inlets 11 may be spaced equidistantly about the macerator housing 16. The inlet slurry may be provided at pressure to the inlet of the macerator. In some embodiments the rotation of the bodies is configured to draw in said inlet slurry.

The inner 14 and outer 15 bodies of the macerator 10 may be separated from each other by less than about 0.1, 0.2, 0.3, 0.4, 0.5, 0.6, 0.7, 0.8, 0.9 or 1.0 mm, and suitable ranges may be selected from between any of these values, (for example, about 0.1 to about 1.0, about 0.1 to about 0.8, about 0.1 to about 0.5, about 0.2 to about 1.0, about 0.2 to about 0.9, about 0.2 to about 0.7, about 0.2 to about 0.5, about 0.3 to about 1.0, about 0.3 to about 0.7, about 0.3 to about 0.5, about 0.4 to about 1.0, about 0.3 to about 0.8, about 0.4 to about 1.0, about 0.4 to about 0.7, about 0.5 to about 1.0, about 0.5 to about 0.8, about 0.6 to about 1.0, about 0.6 to about 0.9, about 0.7 to about 1.0, about 0.7 to about 0.9 or about 0.8 to about 1.0 mm).

The rotation of the inner 14 body relative to the outer 15 body applies a shear stress to the plastic particles as they pass through the apertures 16 of the outer body 15 through the intermediate space between the outer body 15 and the inner body 14 and through the apertures 16 of the inner body 14, to the outlet.

In relation to the inlet particle size it will be appreciated that the dimensions of the slot or aperture will be dependent on the inlet particle size for that particular body. For example, as mentioned the particle must be sized to be able to enter through the slot or aperture. If the particle is larger than the slot or aperture then it will not be able to enter the slot or aperture and be cut. Additionally, consideration must be had of the velocity of relative rotation of adjacent bodies. That is, the time at which the slots or apertures in successive bodies line up and then close is called the time to closure. For example, at some point the slot or aperture of adjacent bodies will line up and then the gradually close as the bodies rotate relative to each other. Thus the slot or aperture 16 must be larger than the size of the particle to provide additional slot or aperture width for the particle to traverse. The rate of closure will increase as the relative rotational speed of adjacent bodies increased.

In one embodiment the slot or aperture width is at least 3.5, 4.0, 4.5, 5.0, 5.5, 6.0, 6.5, 7.0, 7.5, 8.0, 8.5× the average particle size of the plastic particles traversing that slot or aperture, and suitable ranges may be selected from between any of these values, (for example, about 3.5 to about 8.5, about 3.5 to about 7.5, about 3.5 to about 6.0, about 3.5 to about 5, about 4.0 to about 8.5, about 4.0 to about 8.0, about 4.0 to about 7.0, about 4.0 to about 6.5, about 4.5 to about 8.5, about 4.5 to about 7.5, about 4.5 to about 5.5, about 5.0 to about 8.5, about 5.0 to about 8.0, about 5.5 to about 7.5, about 5.5 to about 6.5, about 6.0 to about 8.5, about 6.0 to about 8.0, about 6.5 to about 7.5× the average particle size of the plastic particles traversing that slot or aperture).

In some embodiments, the apertures 16 of the inner body 14 may be approximately half the size of the apertures 16 of the outer body 15, or the apertures 16 of the outer body 15 are approximately twice the size of the apertures 16 of the inner body 14. The reason for this is that as the plastic particles traverse the outer bodies they are cut to a smaller size, and thus the next bodies' aperture size can be decreased.

Alternately, where there are three or more bodies 13, the rotational speed of the third body could be increased which will increase the rate of closure of the second body relative to the third body, but due to the smaller particle size the particles will still traverse through the aperture or slot.

Thus in one embodiment the slot or aperture width of successive bodies decreases. Alternately, the rotational speed of successive bodies increases to increase the rate of closure. Alternately, a combination of the two could be done. That is increasing the rate of rotation of successive bodies while also decreasing width of the slot or aperture.

In some embodiments, the outlet 12 of the macerator is provided internal to the inner body 14, and the inlet 11 is provided external to the outer body 15.

The macerator 10 may comprise a housing to house the bodies 13. In some embodiments, a motor may be coupled or connected to said housing so as to rotate the inner body 14 relative to the outer body 15.

The outlet slurry from the macerator 10 may have a plastic particle size being less than a predetermined plastic particle size. In some embodiments, the predetermined particle size is less than about 20, 19, 18, 17, 16, 15, 14, 13, 12, 11, 10, 9, 8, 7, 6, 5, 4, 3, 2, 1, or 0.5 μm, and suitable ranges may be selected from between any of these values.

The apertures 16 may be or comprise one or more slots or apertures 17. The slots or apertures 17 may be located vertically, and/or in a direction from the top of the body to the bottom of the body. The slots or apertures 17 may be oriented in a direction along or parallel with an axis of rotation or the body. In some embodiments, the slots or apertures 17 may be oriented in a direction with respect to a length of the body.

In some embodiments, the slots or apertures 17 may be angled with respect to a vertical or axial axis (“C” of FIGS. 4 and 19), or an axis of rotation of the body, or an axis parallel to a vertical or axial axis, or an axis of rotation of the body. In some embodiments, the slots or apertures 17 may be angled with respect to a length of the body. As shown in FIGS. 4 and 19 the slots or apertures are angled relative to a vertical or horizontal axis (i.e. which ever is the axis of rotation which depends on the orientation of the macerator). In one embodiment the slots or aperture are angled 3, 4, 5, 6, 7, 8, 9, 10, 11, 12, 13, 14, 15, 16, 17, 18, 19 or 20% from the axis of rotation, and suitable ranges may be selected from between any of these values, (for example, about 3 to about 20, about 3 to about 17, about 3 to about 15, about 3 to about 12, about 3 to about 11, about 3 to about 10, about 3 to about 9, about 3 to about 8, about 3 to about 7, about 3 to about 6, about 4 to about 20, about 4 to about 15, about 4 to about 13, about 4 to about 10, about 4 to about 8, about 4 to about 7, about 4 to about 6, about 5 to about 20, about 5 to about 15, about 5 to about 12, about 5 to about 10, about 5 to about 9, about 5 to about 8, about 5 to about 7, about 5 to about 6, about 6 to about 20, about 6 to about 15, about 6 to about 14, about 6 to about 11, about 6 to about 9, about 6 to about 8, about 7 to about 20, about 7 to about 15, about 7 to about 14, about 7 to about 13, about 7 to about 10, about 7 to about 8, about 8 to about 20, about 8 to about 15, about 8 to about 10, about 9 to about 20, about 9 to about 15, about 9 to about 13% from the axis of rotation).

In one embodiment the slots or apertures of a single body may be angled from the axis of rotation at any one of a range of angles. For example, some slots or apertures may be angled from the axis of rotation at a first angle, and other slots or apertures at a different angle. It should be appreciated that a range of different angles could be used, and that not all slots or apertures are required to be at the same offset angle.

The bodies may comprise multiple banks or rows of slots or aperture. In one configuration a body comprises 2, 3, 4, 5 or 6 banks or rows of slots or apertures, each bank or row of slots or apertures extending the circumference of the body. For example, as shown in FIG. 4 the body has two banks or rows of slots or apertures. Alternately, in FIGS. 18 and 19 the body has 3 banks or rows of slots or apertures.

Again, the slots or apertures may not all be angled with the same angle. In one embodiment one row of slots or apertures may have a first angle and another row of slots or apertures a second angle. Alternately the offset angle of the slot and apertures of the body, regardless of which row of slots or apparatus may be different.

In one embodiment the slots or apertures or successive bodies are angled oppositely to each other. For example, where an outer body has the slots or apertures angled +7.5% relative to the axis of rotation, the next body has the slots or apertures angled −7.5% relative to the axis of rotation. Thus, the relative angle of the slots or apertures to each other is doubled in this instance to 15°. It will be appreciated that each body can have the slots angled at any angle as mentioned above between 3 and 15 but in this instance each successive body has them angled oppositely relative to the axis of rotation so that the angle of the slots of adjacent bodies is the cumulative angle of both bodies.

In some embodiments, the slots of the outer body are wider than the slots of the inner body. For example, the slots of the outer body may be about 1.5 to about 2.5 times wider than the slots of the inner body. As a further example, the slots of the outer body may be about 2 times wider than the slots of the inner body.

In some embodiments, at least one slot of the outer body comprises a projection from the outer surface of the outer body. This projection may comprise a blade.

The projection from the outer surface of the outer body preferably extends in the direction of rotation of the outer body at an acute angle relative to the outer surface of the outer body. For example, the projection may extend at an angle of about 5, 10, 15, 20, 25 or 30 degrees. As a further example, the projection may extend at an angle of about 15 degrees.

In some embodiments a width of the one or more slots 17 is substantially constant along a length of the slot 17. In some embodiments the width of the slots 17 varies along a length of the slot 17.

The slots 17 may vary in width from an outer surface of the body to an inner surface of the body. The slots 17 may taper in width from an outer surface of the body to an inner surface of the body, or from an inner surface of the body to an outer surface of the body.

The slot at an outer surface may be greater than a width of the slot at an inner surface. The width of the slot at an inner surface is greater than a width of the slot at an outer surface.

The width (i.e. in the direction of rotation) of the one or more aperture or slots 17 of a body may be about 1, 2, 3, 4, 5, 6, 7, 8, 9, 10, 11, 12, 13, 14 or 15 mm, and suitable ranges may be selected from between any of these values (for example, 1 to about 15, about 1 to about 12, about 1 to about 10, about 1 to about 8, about 2 to about 15, about 2 to about 13, about 2 to about 11, about 2 to about 9, about 2 to about 7, about 3 to about 15, about 3 to about 14, about 3 to about 10, about 3 to about 8, about 4 to about 15, about 4 to about 13, about 4 to about 11, about 4 to about 10, about 407, about 5 to about 15, about 5 to about 14, about 5 to about 12, about 5 to about 10, about 5 to about 8, about 6 to about 15, about 6 to about 13, about 6 to about 12, about 6 to about 8, about 7 to about 15, about 7 to about 14, about 7 to about 11, about 7 to about 9, about 8 to about 15, about 8 to about 14, about 8 to about 11, about 9 to about 15, about 9 to about 13, about 9 to about 11, about 10 to about 15, about 10 to about 13, about 11 to about 15, about 11 to about 14 or about 12 to about 15 mm).

The width (i.e. in the direction of rotation) of the one or more slots 17 may be between about 1 and about 15 mm, or about 1 mm, or about 3 mm, or about 4 mm, or about 5 mm, or about 6 mm, or about 7 mm, or about 8 mm, or about 9 mm, or about 10 mm, or about 11 mm or about 12 mm, or about 13 mm, or about 14 mm, or about 15 mm, or about 16 mm, or about 17 mm, or about 18 mm, or about 19 mm, or about 20 mm.

The inner body 14 may be rotatable about an axial axis, and the outer body 15 may be stationary.

Alternatively, the outer body 15 may be rotatable about an axial axis, and the inner body 14 is stationary.

In some embodiments the inner body may be configured to provide for an inlet flow path for the pair of bodies, may be stationary, and the outlet body configured to provide for an outlet flow path for the pair of bodies may be rotating.

One or more of the inner body 14 and the outer body 15 are rotatable about an axial axis.

The macerator 10 may comprise an inner body shaft 20. The inner body shaft 20 may be coupled to the inner body 14 and/or one or more inner bodies to allow for rotation of the inner body 14 and/or one or more inner bodies relative to an axial axis of the inner body and/or one or more inner bodies. In some embodiments, the inner body shaft 20 is provided with a pair of high speed water cooled bearings to allow for rotation of the inner body shaft 20.

In one embodiment each of the bodies of the macerator 10 are on a common shaft. In one embodiment the bodies are connected to a shaft, with each bodies shaft being located within another shaft. Preferably the macerator comprises a gear box that allows for one or more bodies of the macerator to have a direction of rotation different to one or more of other bodies of the macerator 10.

The macerator 10 may comprise an outer body shaft 21. The outer body shaft 21 may be configured to be coupled to the outer body 21 and/or one or more outer body to allow for rotation of the outer body 15 and/or one or more outer body relative to an axial axis of the outer body 15 and/or one or more outer body. In some embodiments, the outer body shaft 21 is provided with a pair of high speed water cooled bearings to allow for rotation of the inner body shaft 20.

The inner body shaft 20 and/or the outer body shaft 21 may be coupled to at least one motor 22. The at least one motor 22 may be configured to rotate the inner body shaft 20 and/or the outer body shaft 21.

The macerator 10 may include a liquid cooled bearing (not shown) on the body shaft. The advantage of this design is that the slurry liquid is used to cool the bearing, which would otherwise operate at high temperatures due to the heat produced by the maceration of the plastic.

The inner body 14 or the outer body 15 may be an inlet body configured to provide for an inlet flow path for the pair of bodies. The other of the inner body 14 or the outer body 15 may be an outlet body configured to provide for an outlet flow path for the pair of bodies.

A width or other dimension, or largest dimension of the at least one aperture 16 of the inlet body 14 may be greater than a width or other dimension, or largest dimension of the at least one aperture 16 of the outlet body 15.

The macerator 10 may comprise a plurality of pairs of bodies. Each pair of bodies may be located concentrically with respect to each other pair of bodies.

The macerator 10 may comprise at least a first pair of bodies, and a second pair or bodies. In some embodiments the macerator 10 may comprise a third pair or bodies. In some embodiments the macerator 10 may comprise one or more further pairs of bodies.

The flow path from an inlet of the macerator 10 to the outlet of the macerator 10 may be through the first pair of bodies, followed by the second pair or bodies, and optionally through the third pair or bodies, and optionally through said one or more further pairs of bodies.

The progression of the slurry through each pair of bodies is configured to progressively decrease a particle size of plastic in the slurry. The number of pairs of bodies, the size of the apertures in the each body, and the distance between the pair of bodies may be customised based on the characteristics of the inlet slurry, and the desired characteristics of the outlet slurry. In some embodiments, the surface area of the bodies may be based on the desired flow rate of inlet slurry and/or the desired outlet particle size.

The first pair of bodies may comprises an inlet body (being one of the inner body or the outer body), and a width or other dimension, or largest dimension of the apertures of the inlet body, for example, may be about 20 mm.

The first pair of bodies may comprises an outlet body (being the other of the inner body and the outer body), and a width or other dimension, or largest dimension of the apertures of the outlet body, for example, may be about 17 mm.

The second pair of bodies may comprise an inlet body (being one of the inner body or the outer body) wherein a width or other dimension, or largest dimension of the apertures of the inlet body, for example, may be about 17 mm.

The second pair of bodies may comprise an outlet body (being the other of the inner body and the outer body) wherein a width or other dimension, or largest dimension of the apertures of the outlet body, for example, may be about 12 mm.

The third pair of bodies may comprise an inlet body (being one of the inner body or the outer body) wherein a width or other dimension, or largest dimension of the apertures of the inlet body, for example, may be about 12 mm.

The third pair of bodies may comprise an outlet body (being the other of the inner body and the outer body) wherein a width or other dimension, or largest dimension of the apertures of the outlet body, for example, may be about 3 mm.

The flow path from the macerator inlet to the macerator outlet may be provided through the apertures of each body of each pair of bodies.

The flow path from the macerator inlet to the macerator outlet may be provided from an innermost body to an outermost body via each intermediate body.

The flow path from the macerator inlet to the macerator outlet may be provided from an outermost body to an innermost body via each intermediate body.

The flow of inlet slurry may be provided to internal surface of the inner body 14 and/or an internal surface of the inner body 14 of the innermost pair of bodies. For example where the inner body 14 of the innermost pair of bodies acts as an inlet body.

The flow of inlet slurry may be provided to external surface of the outer body 15 and/or an external surface of the outer body 15 of the outermost pair of bodies. For example where the outer body 15 of the outermost pair of bodies acts as an inlet body.

In one embodiment the flow of slurry may be across the macerator as shown in FIG. 1B. For example, the inlet may be to the bottom of the macerator as shown in FIG. 1B and then flows through the macerator and outlets the top of the macerator. That is, the slurry goes through each layer of body to the centre of the macerator and then traverses each layer of the bodies to outlet the macerator.

Therefore, for a macerator with a pair of bodies, the slurry will traverse two pairs of slots or apertures between the inlet and the outlet. With a macerator having three bodies, the slurry will traverse six slots or apertures, three on the bottom of the macerator and then three on the way to the outlet from the centre of the macerator. It will be appreciate that the macerator will include baffles or blockages to prevent the slurry from going around the side of the bodies. That is, the macerator will include one or more flow guides that direct the slurry though the slot or apertures of the macerator. In this embodiment the fact that plastic floats is useful as it assist s the plastic from moving through the macerator from the bottom to the top across the bodies. Combined with inletting the slurry at pressure assists movement of the particles across the macerator.

In one embodiment the inlet of slurry to the macerator is substantially spread along the length of the macerator. Preferably the inlet comprises a manifold.

In some embodiments the inlet body is stationary, and the outlet body rotates relative to the inlet body.

The inlet slurry may comprises plastic particles having a particle size of 4 mm to 20 mm, and optionally around 8 mm.

The outlet slurry may comprise plastic particles having a particle size of less than 4 mm.

The outlet slurry (after passing through the macerator 10) may comprise plastic particles having a plastic particle size. The plastic particle size is less than a predetermined plastic particle size.

In some embodiments, the predetermined plastic particle size is less than 0.5, 1, 2, 3 or 4 mm.

In some embodiments, if the plastic particle size is greater than the predetermined plastic particle size the outlet slurry may be directed to the macerator inlet 11 (for example cycled through the macerator 10 again), and/or to another macerator inlet 11 (for example to a further macerator inlet 11 of another macerator 10) until the outlet slurry has a particle size being less than the predetermined particle size.

In some embodiments the flow rate of inlet slurry provided to the macerator 10 may be based on one or more of: the plastic type and its particular characteristics for example the plastic melting point, the size of the apertures in the bodies, the overall surface are of the bodies, or the ratio of liquid to plastic in the slurry.

Also disclosed is a system 50 for processing plastic. The system may comprise an inlet configured to receive a system inlet slurry comprising plastic particles, and an outlet configured to deliver a system outlet slurry. The system may also comprise a maceration stage 51. The maceration stage 50 decreases the particle size of the plastic particles within the slurry, as the slurry passes through the maceration stage 51. The maceration stage 51 may comprise one or more macerator 10, as described above. The system inlet slurry may be provided to the maceration stage 51 so as to produce the system outlet slurry.

The system may comprise a plurality of macerators. At least two of the plurality of macerators may be arranged in series. Alternatively or additionally, at least two of the plurality of macerators may be arranged in parallel.

The outlet slurry of one of the one or more macerators 10 may be configured to be directed to the inlet of another of the one or more macerators, and/or to the inlet of the same macerator 10.

The system 50 may comprise at least a first macerator 52, and a second macerator 53, optionally the system comprises a third macerator 54, and optionally one or more further macerators 55.

One or more filter elements may be located between the output of one macerator and the input of another macerator. The one or more filter elements may filter out or prevent the passing of particles above a certain particle size. The one or more filter elements may be configured to ensure particles which are too large for the subsequent macerator (for example particles which might cause the macerator to become clogged) are not provided to the subsequent or next macerator.

A flow path may be provided from the inlet of the system to the outlet of the system via the first macerator 52, followed by the second macerator 53, and optionally followed by the third macerator 54, and optionally followed by one or more further macerators 55.

The first macerator 52 may comprise an inlet body (being one of the inner body 14 or the outer body 15). A width or other dimension, or largest dimension of the apertures 16 of the inlet body is about 20 mm, and an outlet body (being the other of the inner body and the outer body) wherein a width or other dimension, or largest dimension of the apertures of the outlet body is about 17 mm.

The second macerator 53 may comprise an inlet body (being one of the inner body or the outer body). A width or other dimension, or largest dimension of the apertures of the inlet body is about 17 mm, and an outlet body (being the other of the inner body and the outer body) wherein a width or other dimension, or largest dimension of the apertures of the outlet body is about 12 mm.

The third macerator 54 may comprise an inlet body (being one of the inner body or the outer body). A width or other dimension, or largest dimension of the apertures of the inlet body is about 12 mm, and an outlet body (being the other of the inner body and the outer body) wherein a width or other dimension, or largest dimension of the apertures of the outlet body is about 3 mm.

The system outlet slurry may comprise plastic particles having a plastic particle size. In some embodiments the plastic particle size is less than a predetermined plastic particle size.

In some embodiments, if the plastic particle size is greater than the predetermined plastic particle size the outlet slurry of one of the plurality of macerators is directed to the macerator inlet (for example being cycled back into the same macerator), and/or to another macerator inlet (for example of another macerator 10 of the plurality of macerators) until the outlet slurry has a particle size of less than the predetermined particle size.

The inlet slurry may be recycled through the maceration stage 51 until the outlet slurry has a particle size of less than the predetermined particle size.

The time to pass through the macerator may be controlled by modifying the speed of relative rotation between the inner body and the outer body, and/or the spacing between the inner body and the outer body, and/or the flow rate of the slurry, and/or the particle sizes of the particles in the slurry.

In some embodiments, the flow rate of the solvent through the macerator 10 may be about 10 litres per minute to about 1000 litres per minute. In particular, the flow rate of the solvent through the macerator 10 may be approximately 100 litres per minute.

In some embodiments, the ratio of carrier solvent such as water to plastic provided to the macerator is at a ratio of approximately 1 litre to 0.5 kg, to approximately 1 litre to 1.5 kg.

In some embodiments, the ratio of carrier solvent such as water to plastic provided to the macerator is at a ratio of approximately 1 litre to 1 kg.

The binder is mixed with the substrate to form the composite material that is then moulded to form the product. The composite material is moulded under pressure and heated to a temperature between 100° C. and 220° C.

As mentioned above, the substrate can be a cellulosic material such as a wood-based material, coconut husk, paper or cardboard.

If a wood-composite product is desired then the substrate may include both a fine and coarse wood substrate as mentioned above. The board is formed by first preparing a fine mixture and a course mixture. The fine mixture is prepared by mixing the fine wood fibre with the binder that comprises the plastic and cross linker. The coarse mixture is prepared by mixing the coarse wood fibre with the binder, that comprises the plastic and the cross linker.

When forming a board the board is formed by first layering the fine mixture in the base of the mould, then the coarse mixture and then the fine mixture on top to sandwich the coarse mixture. The prepared composite material is then pressed under pressure and temperature.

In some embodiments the ratio of fine mixture to coarse mixture is about 20:80 to 80:20. It will be appreciated that when the fine mixture is prepared that it can be divided into use as the top and bottom layer. Typically the ratio of division is from 40:60:60:40, and about 50:50 is preferred.

The ratio of coarse mixture to the fine mixture may be between 20:80 to 80:20 as mentioned above, and a ratio of 40:60 to 60:40 are also contemplated.

In one preferred embodiment the board is formed from 20% by weight fine mixture, 60% by weight of the coarse mixture and then 20% by weight of the fine mixture.

In relation to a plywood style composite product, the binder is placed between the sheets, for example by spraying or spreading of the binder.

When the composite material is placed in the press it is subjected to pressure. The thickness of the composite material decreases under pressure such that the cured final product may be about 10, 15, 120, 25, 30 or 35% of the thickness of the original composite material mixture prior to pressure and heat.

The starting pressure applied to the mould may be about 500 kg/m² to about 2000 kg/m², but this pressure decreases as the plastics cures as the composite mixture reduces in thickness.

The pressure applied to the composite mixture may be about 3, 4, 5, 6, 7, 8, 9 or 10 MPa, and suitable ranges may be selected from between any of these values (for example, about 3 to about 10, about 3 to about 9, about 3 to about 7, about 3 to about 6, about 3 to about 5, about 4 to about 10, about 4 to about 8, about 4 to about 6, about 5 to about 10, about 5 to about 8, about 5 to about 7, about 6 to about 10, about 6 to about 9 or about 7 to about 10 MPa).

The temperature of the press or mould is such that the composite material is heated to about 100 to about 220° C. This is a temperature sufficient to melt the plastic allowing it to coat and bind the substrate and form the product. In some embodiments it may not be desired to melt all of the plastic. That is, while enough plastic may be melted to form a continuous phase that coats the substrate, some plastic may remain unmelted and remain as a particulate in the composite material.

It will be appreciated that the top and bottom fine mixture layers may be exposed to greater heating compared to the inner coarse mixture layer. Given this, the plastic used in the binder of the fine mixture may comprise plastics having a higher melting point compared to the plastic used in the binder for the coarse mixture (used in the middle layer of the board).

The method for manufacturing a composite panel may first comprise the step of combining a binder comprising water and a particularised plastic and a fibrous or particulate substrate within a press or mould. The particularised plastic may be a mixture of low-melt and high melt plastic. In one embodiment the low-melt particulate plastics has a particle size less than 4 mm and a melting point of 130° C. or less. This melting point is sufficient to melt low-density polyethylene and high-density polyethylene. The high-melt particulate plastics are plastics that have a melting point greater than 130° C., such as PVC, PET, PP and ABS. The composite mixture is subjected to pressure sufficient to decrease the thickness of the composite mixture and heating the composite mixture to about 100° C. to about 220° C. to form the wood composite panel.

In some embodiments the particle size of the particularised plastic may be smaller for the fine fibre compared to the coarse fibre. That is, to achieve effective coating of the fine fibre this may be best achieved by utilising plastic particles with a finer average particle size to ensure good coating of the fine fibres.

In some embodiments the cross linker used between the fine mixture and the coarse mixture may be different. For example, the cross linker used in the fine mixture may be selected based on performance at higher temperatures, whereas the cross linker used in the coarse layer may be selected based on its performance at a lower temperature.

In some embodiments the moisture content of the fine layer may be increased relative to the coarse layer.

The composite mixture may also comprise an additive. The additive may be present in the binder. The additive may be selected from any one or more of
a) an accelerator,
b) a modifier,
c) an activator, and/or
d) a catalyst.

In relation to the accelerator, the accelerator may be an amine based accelerator. More particularly the accelerator may be a toluidine based accelerator. Specifically, the accelerator may be selected from N-(2-Hydroxylethyl)-N-Methyl-para-Toluidine, ethoxylated para-Toluidine, N,N-Dimethyl-p-Toluidine, N,N-Dihydroxyethyl-p-Toluidine, Diisopropoxy-p-Toluidine or a combination thereof.

The binder may comprise 0.5, 1.0, 1.5, 2.0, 2.5, or 3.0 by weight of the binder of accelerator, and suitable ranges may be selected from between any of these values.

Without wishing to be bound by theory the accelerator increases the amount of free radicals by the cross linking agent, which increases the rate of polymerisation of the thermoplastic material to theromoset material.

The boards produced may have a modulus of elasticity (MoE) of about 1,000, 1500, 2000, 2500, 3000, 3500 or 4000 MPa. Static bending is often used for machine stress rating (MSR) of timber-based products. MSR is currently the most common dynamic, mechanical load procedure. Boards are fed through a machine flat wise, longitudinally and bent by rollers upwards and downwards in two sections. The span between the rollers is typically around 1.2 m. Depending on the design, the machine bends the boards to a constant deflection and measures the required force or the machine bends the boards with a constant force and measures the deflection. Using the load deflection relationship, the local MOE can be determined directly by using equations sourced from fundamental mechanics of material on every point of the board except for approximately the first and last 500 mm. This test method allows the stiffness profile of a board to be determined.

The composite boards produced have a Modulus of Rupture (MOR) of about 5, 10, 15, 20 or 25 Mpa. The MOR (sometimes referred to as bending strength), is a measure of a specimen's strength before rupture. It can be used to determine a wood-based products overall strength; unlike the modulus of elasticity, which measures the wood's deflection, but not its ultimate strength. The MOR “sigma” can be calculated using the equation or =3Fx/yz2 for the load force F and size dimensions in three directions, x, y and z, of the material. In this case, the load is the external force put on the material of interest. The load force is applied to the centre of the composite product of the material elevated slightly above ground.

In some embodiment s the composite product as a surface screw holding of about 200, 250, 300, 350, 400, 450 or 500 N, and suitable ranges may be selected from between any of these values (for example, about 200 to about 500, about 200 to about 400, about 200 to about 300, about 250 to about 500, about 250 to about 450, about 250 to about 350, about 300 to about 500, about 300 to about 450, about 350 to about 500, about 350 to about 450 N).

The density of the composite board can be controlled by the degree of compression applied in the press or mould. For example, a lower pressure can be used to provide a low density composite board having a density of about 550, 560, 570, 580, 590, 600, 610, 620, 630, 640 or 650 kgm³, and suitable ranges may be selected from between any of these values.

A greater pressure can be used to provide a mid density composite board having a density of about 650, 700, 750 or 800 kgm³, and suitable ranges may be selected from between any of these values.

A greater pressure can be used to provide a high density composite board having a density of about 800, 850, 900, 950, 1000, 1050 or 1100 kgm³, and suitable ranges may be selected from between any of these values.

### EXAMPLE

### Example 1—Composite Wood Boards

This example was carried out to produce a range of composite wood boards that differ in their level of binder percentage.

The plastic was processed to a “liquidised” form, that being a particle size of less than 4 mm. The binder, in the form of liquidised HDPE (particularised plastic in water—equal volume of water and binder), was sprayed onto the sawdust substrate within a press. The press was then closed and provided 100-200 tonne of pressure and heating. Once the maximum possible compression was achieved, no extra pressure was added. The weight of the press itself applied pressure. In relation to the 8, 12 and 16% binder boards, due to the limitations of the press being used, 20% to 25% of the material was lost from the press.

The process produced well-formed composite wood boards.

TABLE 1
Wood fibre board using 8, 12, 16 or 20% liquidised HDPE as binder

| | | | | Processing parameters | | | | |
|---|---|---|---|---|---|---|---|---|
| | | | | Core | | Board | Dimensions | |
| | | | | Temp | Curing | thickness | (mm) | Weight |
| | | | | (° C.) | (min) | (mm) | (L × W) | (g) |
| 8% | Binder - | 160 | g | 140 | 40 | 15 | 220 × 195 | 590 |
| | 100% HDPE | | | | | | | |
| | Cross linker | 10 | g | | | | | |
| | Sawdust | 2 | kg | | | | | |
| | Binder - | 160 | g | 140 | 40 | 15 | 270 × 230 | 767 |
| | 100% HDPE | | | | | | | |
| | Cross linker | 10 | g | | | | | |
| | Sawdust | 2 | kg | | | | | |
| 12% | Binder - | 240 | g | 140 | 40 | 15 | 300 × 230 | 879 |
| | 100% HDPE | | | | | | | |
| | Cross linker | 10 | g | | | | | |
| | Sawdust | 2 | kg | | | | | |
| | Binder - | 240 | g | 140 | 40 | 15 | 270 × 200 | 678 |
| | 100% HDPE | | | | | | | |
| | Cross linker | 10 | g | | | | | |
| | Sawdust | 2 | kg | | | | | |
| 16% | Binder - | 320 | g | 140 | 40 | 15 | 230 × 150 | 456 |
| | 100% HDPE | | | | | | | |
| | Cross linker | 10 | g | | | | | |
| | Sawdust | 2 | kg | | | | | |
| | Binder - | 320 | g | 140 | 45 | 15 | 300 × 210 | 807 |
| | 100% HDPE | | | | | | | |
| | Cross linker | 10 | g | | | | | |
| | Sawdust | 2 | kg | | | | | |
| 20% | Binder - | 400 | g | 140 | 40 | 13 | 290 × 150 | 844 |
| | 100% HDPE | | | | | | | |
| | Cross linker | 10 | g | | | | | |
| | Sawdust | 2 | kg | | | | | |
| | Binder - | 400 | g | 140 | 40 | 15 | 300 × 210 | 791 |
| | 100% HDPE | | | | | | | |
| | Cross linker | 10 | g | | | | | |
| | Sawdust | 2 | kg | | | | | |

The above boards were trimmed to a particular size and then tested using a destructive test that exposes the boards to a force applied at a speed of 50 mm/min spanning across supports with radius 15 mm at a span of 215 mm.

TABLE 2
Test to destruction results

| | Dimensions | | | | | |
|---|---|---|---|---|---|---|
| | (mm) | Load | | Force | MOE | MOR |
| | (L × W × H) | (Kg) | (mm) | (N) | MPa | MPa |
| 8% binder | 265 × 100 × 15 | 22.6 | 4.5 | 221.9 | 487.6 | 3.2 |
| 8% binder | 225 × 100 × 16 | 18.9 | 5.2 | 185.3 | 311.6 | 2.3 |
| 12% binder | 265 × 100 × 15 | 56.8 | 5.3 | 557.1 | 918.2 | 8.0 |
| 12% binder | 270 × 100 × 15 | 27.5 | 5.3 | 269.8 | 480.6 | 3.9 |
| 16% binder | 270 × 100 × 15 | 43.5 | 5.1 | 427.0 | 750.2 | 6.1 |
| 16% binder | 225 × 100 × 20 | 10.9 | 5.6 | 106.9 | 80.1 | 0.9 |
| 20% binder | 270 × 100 × 15 | 67.5 | 4.8 | 662.3 | 1153.6 | 9.5 |
| 20% binder | 270 × 100 × 14 | 46.0 | 5.9 | 451.6 | 796.0 | 7.4 |

A further test was conducted using a binder formed from a mixture of plastics.

The wood substrate was split into coarse and fine fibres. The fine fibres were weighed and put into a mixing unit. The binder was weighed and sprayed onto the fine fibres using a hand-held spray gun with hopper. The mixing unit then blended the fines and the binder together for about five minutes. The fines mix is then removed from the mixing unit, weighed, and split into two portions of equal weight in order to facilitate the layering. The coarse fibres are weighed and put into the mixing unit. Binder is weighed and sprayed into the coarse fibres using a hand-held spray gun with hopper. The mixing unit blends the fines and the binder together for five minutes. The coarse mix was then removed from the mixing unit and weighed accordingly. Next, the wooden custom mould was placed on a metal plate and the first portion of the fines is poured into it and compressed using a hand-held flat-faced device to provide pre-compression. This was then followed by pouring the coarse mix and compressing. We then poured the second fine mix portion on top of the coarse mix, thus providing layering. A steel plate was kept on top of the mix and is then pushed into the press or mould. The mix was then compressed up to capacity and left in the mould to cure under heat. Once the core temperature reached 140° ° C. the press was shut off and the mould removed for ambient cooling.

The blend of PET, PVC, PC, PP was present as an approximately 5 mm diameter pellet. The HPDE was processed to a particle size of about 2-4 mm. Press pressure of 100 tonnes that reduces to 80 tonnes at the end of the process.

In this example the coarse fibres constituted 40% by weight of the total mix and the fines accounted for 60% by weight of the total mix. The binder % is calculated based on the weight of the coarse and fines used respectively. The binder is sprayed separately into the coarse and fine fibres as their % proportion varies. We found that the average time for production inside the press is approximately 45 minutes.

The boards then cooled at ambient for a further 75 minutes once the mould was removed from the press.

In these examples we have used both virgin PE binder and waste PE binder. The virgin PE is sprayed directly into the mix whereas for the waste PE binder, the binder was mixed with equal volumes of water before spraying.

Where a cross-linker is used, it is already present within both binder blends.

TABLE 3
Wood fibre board formed from 20% of a mixed plastics binder

| | | | | Core | |
|---|---|---|---|---|---|
| | | | Amount | Temp | |
| | | | (%) | (° C.) | Comments |
| 1 | 20% Binder | HDPE/LDPE | 80 | 140 | 30 mm lost |
| | | PET, PVC, PC | 2.4 | | each side due |
| | | LDPE, PP, | | | to board |
| | | sugar bio | 17.6 | | crumbling |
| | 80% Substrate | Coarse Fibre | 60 | | |
| | | Fines | 40 | | |
| 2 | 20% Binder | HDPE/LDPE | 60 | 140 | Board stuck |
| | | PET, PVC, PC | 4.8 | | to plate, broke |
| | | LDPE, PP, | 35.2 | | into pieces on |
| | | sugar bio | | | removal |
| | 80% Substrate | Coarse Fibre | 60 | | |
| | | Fines | 40 | | |

As shown in Table 4 below a wood fibre board was formed as a sandwich of layers of course and fine wood fibres, being a fine mix that sandwiches a course mix. No water was added to the binder. The core was heated to 180° C.

TABLE 4
Wood fibre board using 12% or 30% liquidised HDPE as binder

| | | | Processing parameters | | | |
|---|---|---|---|---|---|---|
| | | | | | Dimensions | |
| | | | | Board | (mm) | |
| | | (g) | Curing (min) | thickness (mm) | (L × W) | Weight (g) |
| 12% | Course mix (60%) | | 18 | 16 | 300 × 300 | 1440 |
| | binder (HDPE) | 144 | | | | |
| | cross linker | 6 | | | | |
| | course wood fibre | 1200 | | | | |
| | Fine mix (40%) | | | | | |
| | binder | 96 | | | | |
| | cross linker | 4 | | | | |
| | fine wood fibre | 800 | | | | |
| | Course mix (60%) | | 15 | 18 | 300 × 300 | 1700 |
| | binder (HDPE) | 144 | | | | |
| | cross linker | 6 | | | | |
| | course wood fibre | 1200 | | | | |
| | Fine mix (40%) | | | | | |
| | binder (HDPE) | 96 | | | | |
| | cross linker | 4 | | | | |
| | fine wood fibre | 800 | | | | |
| 30% | Course mix (60%) | | 25 | 18 | 350 × 300 | 1800 |
| | binder (HDPE) | 360 | | | | |
| | cross linker | 6 | | | | |
| | course wood fibre | 1200 | | | | |
| | Fine mix (40%) | | | | | |
| | binder (HDPE) | 240 | | | | |
| | cross linker | 4 | | | | |
| | fine wood fibre | 800 | | | | |

The above boards were cut into six 50 mm strips with the first three strips front analysed for MoE and MoR and the remaining three strips rear analysed for MoE and MOR. The strips are labelled 1 to 3, with 1 being the outer most strips of the board, and 3 being the two central strips of the board.

TABLE 5
Strength testing the boards of Table 4.

| | | | | | Deflection | | | |
|---|---|---|---|---|---|---|---|---|
| | Binder | | Length | Fmax | @ Fmax | Speed | Em | fm |
| | (%) | | (mm) | (N) | (mm) | (mm/min) | (MoE) | (MoR) |
| Front | 12 | 1 | 350 | 416.2 | 7.9 | 10 | 2970.4 | 14.6 |
| | | 3 | 350 | 587.4 | 8.8 | 10 | 3972.2 | 20.7 |
| | | 2 | 350 | 481.8 | 9.5 | 10 | 3095.0 | 16.9 |
| | 12 | 1 | 330 | 277.3 | 6.4 | 10 | 1924.5 | 7.7 |
| | | 3 | 330 | 480.5 | 7.5 | 10 | 2709.6 | 13.3 |
| | | 2 | 330 | 371.9 | 6.8 | 10 | 1974.1 | 10.3 |
| | 30 | 1 | 350 | 761.1 | 12.0 | 40 | 2861.7 | 21.1 |
| | | 3 | 350 | 1088.5 | 11.0 | 20 | 4464.5 | 30.2 |
| | | 2 | 350 | 875.5 | 10.9 | 10 | 3590.9 | 24.3 |
| Back | 12 | 2 | 350 | 488.5 | 8.0 | 10 | 3691.7 | 17.2 |
| | | 3 | 350 | 552.4 | 8.5 | 10 | 3942.9 | 19.4 |
| | | 1 | 350 | 275.3 | 7.7 | 10 | 2210.7 | 9.7 |
| | 12 | 2 | 330 | 401.6 | 6.5 | 10 | 2787.2 | 11.2 |
| | | 3 | 330 | 461.0 | 6.2 | 10 | 3199.5 | 12.8 |
| | | 1 | 330 | 239.2 | 6.2 | 10 | 1439.0 | 6.6 |
| | 30 | 2 | 350 | 960.3 | 10.6 | 40 | 3767.6 | 26.7 |
| | | 3 | 350 | 985.1 | 10.0 | 20 | 3864.5 | 27.4 |
| | | 1 | 350 | 702.5 | 11.4 | 10 | 2756.1 | 19.5 |

As shown in Table 6 below a wood fibre board was formed as a sandwich of layers of course and fine wood fibres, being a fine mix that sandwiches a course mix. No water was added to the binder. The core was heated to 180° C.

TABLE 6
Wood fibre board using 4, 8, 12 and 16% liquidised PE as binder.

| | | | Processing parameters | | | |
|---|---|---|---|---|---|---|
| | | | | Board | Dimensions | |
| | | | Curing | thickness | (mm) | Weight |
| | | (g) | (min) | (mm) | (L × W) | (g) |
| 4% | Course mix (60%) | | 15-18 | 17 | 300 × 250 | 1650 |
| | binder (waste PE) | 48 | | | | |
| | cross linker | 6 | | | | |
| | course wood fibre | 1200 | | | | |
| | Fine mix (40%) | | | | | |
| | binder | 32 | | | | |
| | cross linker | 4 | | | | |
| | fine wood fibre | 800 | | | | |
| 8% | Course mix (60%) | | 15-18 | 16 | 300 × 250 | 1650 |
| | binder | 96 | | | | |
| | cross linker | 6 | | | | |
| | course wood fibre | 1200 | | | | |
| | Fine mix (40%) | | | | | |
| | binder | 64 | | | | |
| | cross linker | 4 | | | | |
| | fine wood fibre | 800 | | | | |
| 12% | Course mix (60%) | | 15-18 | 16 | 300 × 250 | 1700 |
| | binder | 144 | | | | |
| | cross linker | 6 | | | | |
| | course wood fibre | 1200 | | | | |
| | Fine mix (40%) | | | | | |
| | binder | 96 | | | | |
| | cross linker | 4 | | | | |
| | fine wood fibre | 800 | | | | |
| 12% | Course mix (60%) | | 19 | 16 | 300 × 250 | 1800 |
| | binder | 144 | | | | |
| | cross linker | 6 | | | | |
| | wax | 20 | | | | |
| | course wood fibre | 1200 | | | | |
| | Fine mix (40%) | | | | | |
| | binder | 96 | | | | |
| | cross linker | 4 | | | | |
| | wax | 20 | | | | |
| | fine wood fibre | 800 | | | | |
| 16% | Course mix (60%) | | 15-18 | 16 | 300 × 250 | 1800 |
| | binder | 192 | | | | |
| | cross linker | 6 | | | | |
| | course wood fibre | 1200 | | | | |
| | Fine mix (40%) | | | | | |
| | binder | 128 | | | | |
| | cross linker | 4 | | | | |
| | fine wood fibre | 800 | | | | |

The above boards were cut into five 50 mm strips being with the first three strips front analysed for MoE and MOR and the remaining three strips rear analysed for MoE and MoR. The strips are labelled 1 to 5, with 1 being the left most strip of the board, 3 being the central strips, and 5 being the right most strip. Each of the strips measured 300 mm×50 mm.

TABLE 7
Strength testing the boards of Table 6.

| | | | | | Deflec- | | | |
|---|---|---|---|---|---|---|---|---|
| | | | | | tion @ | Speed | | |
| | Binder | | Wt | Fmax | Fmax | (mm/ | Em | fm |
| | (%) | | (g) | (N) | (mm) | min) | (MoE) | (MoR) |
| Front | 4 | 1 | 213 | 13.6 | 6.2 | 10 | 809.2 | 3.9 |
| | | 3 | 109 | 17.3 | 4.7 | 10 | 1110.6 | 4.9 |
| | | 5 | 203 | 9.9 | 5.1 | 10 | 614.1 | 2.8 |
| | 4 | 2 | 214 | 17.2 | 6.2 | 10 | 1046.2 | 4.9 |
| | | 4 | 205 | 17.9 | 6.2 | 10 | 1002.3 | 5.1 |
| | 4 | 1 | 206 | 11.7 | 4.9 | 10 | 762.5 | 3.3 |
| | | 3 | 213 | 15.8 | 7.1 | 10 | 1303.2 | 4.5 |
| | | 5 | 215 | 22.9 | 5.5 | 10 | 1283.8 | 6.5 |
| | 8 | 1 | 220 | 21.5 | 5.5 | 10 | 1678.3 | 6.9 |
| | | 3 | 219 | 31.5 | 6.4 | 10 | 2102.8 | 10.1 |
| | | 5 | 219 | 20.7 | 5.8 | 10 | 1321.9 | 6.7 |
| | 8 | 2 | 215 | 26.6 | 6.2 | 10 | 1716.2 | 8.5 |
| | | 4 | 217 | 25.5 | 5.3 | 10 | 1730.3 | 8.2 |
| | 8 | 1 | 213 | 16.0 | 7.5 | 10 | 874.7 | 5.1 |
| | | 3 | 217 | 29.8 | 7.4 | 10 | 1230.8 | 9.6 |
| | | 5 | 213 | 23.7 | 6.9 | 10 | 1209.0 | 7.6 |
| | 12 | 1 | 229 | 38.2 | 6.5 | 10 | 1702.0 | 12.3 |
| | | 3 | 227 | 37.8 | 6.0 | 10 | 2382.0 | 12.2 |
| | | 5 | 222 | 28.9 | 7.2 | 10 | 1452.4 | 9.3 |
| | 12 | 2 | 228.0 | 39.3 | 5.6 | 10 | 2645.8 | 12.6 |
| | | 4 | 221.0 | 40.0 | 6.0 | 10 | 2310.2 | 12.9 |
| | 12 | 1 | 227 | 37.7 | 7.0 | 10 | 2136.5 | 12.1 |
| | | 3 | 230 | 45.1 | 6.2 | 10 | 2793.9 | 14.5 |
| | | 5 | 218 | 31.5 | 6.6 | 10 | 1771.3 | 10.2 |
| | 12 + | 2 | 223 | 44.7 | 6.6 | 10 | 2646.4 | 14.4 |
| | wax | 4 | 226 | 42.8 | 6.7 | 10 | 2395.8 | 13.8 |
| | 16 | 1 | 225 | 33.1 | 6.1 | 10 | 1944.6 | 10.7 |
| | | 3 | 225 | 43.9 | 6.3 | 10 | 2724.9 | 14.1 |
| | | 5 | 220 | 40.4 | 6.7 | 10 | 2213.1 | 13.0 |
| | 16 | 2 | 226.0 | 47.7 | 6.9 | 10 | 2436.1 | 15.4 |
| | | 4 | 245.0 | 68.3 | 7.6 | 10 | 3512.2 | 22.0 |
| | 16 | 1 | 235 | 44.2 | 6.3 | 10 | 2436.4 | 14.2 |
| | | 3 | 237 | 54.0 | 6.3 | 10 | 3088.5 | 17.4 |
| | | 5 | 230 | 31.3 | 6.5 | 10 | 1876.2 | 10.1 |
| Back | 4 | 2 | 215 | 16.2 | 5.7 | 10 | 955.2 | 4.6 |
| | | 4 | 209 | 15.0 | 6.2 | 10 | 915.6 | 4.3 |
| | 4 | 1 | 205 | 13.8 | 6.0 | 10 | 807.7 | 3.9 |
| | | 3 | 211 | 14.1 | 5.8 | 10 | 1040.9 | 4.0 |
| | | 5 | 205 | 13.7 | 5.7 | 10 | 875.8 | 3.9 |
| | 4 | 2 | 213 | 14.9 | 5.5 | 10 | 1086.6 | 4.3 |
| | | 4 | 212 | 20.7 | 4.7 | 10 | 1372.6 | 5.9 |
| | 8 | 2 | 212 | 24.3 | 6.6 | 10 | 2143.2 | 7.8 |
| | | 4 | 215 | 29.2 | 6.9 | 10 | 1862.2 | 9.4 |
| | 8 | 1 | 220 | 17.5 | 6.7 | 10 | 982.5 | 5.6 |
| | | 3 | 218 | 30.8 | 6.4 | 10 | 1778.8 | 9.9 |
| | | 5 | 218 | 18.4 | 6.8 | 10 | 1099.2 | 5.9 |
| | 8 | 2 | 216 | 27.1 | 6.9 | 10 | 1597.9 | 8.7 |
| | | 4 | 220 | 22.7 | 7.1 | 10 | 1605.3 | 7.3 |
| | 12 | 2 | 227 | 41.6 | 6.3 | 10 | 2421.8 | 13.4 |
| | | 4 | 219 | 29.5 | 6.7 | 10 | 1835.1 | 9.5 |
| | 12 | 1 | 221 | 29.7 | 6.2 | 10 | 1754.1 | 9.6 |
| | | 3 | 229 | 45.4 | 7.0 | 10 | 2619.3 | 14.6 |
| | | 5 | 220 | 32.6 | 7.9 | 10 | 1533.6 | 10.5 |
| | 12 | 2 | 229 | 45.7 | 6.5 | 10 | 2631.3 | 14.7 |
| | | 4 | 223 | 39.1 | 6.6 | 10 | 2267.3 | 12.6 |
| | 12 + | 1 | 215 | 24.5 | 6.4 | 10 | 2016.0 | 11.1 |
| | wax | 3 | 228 | 44.5 | 6.6 | 10 | 2627.1 | 14.3 |
| | | 5 | 209 | 32 | 8.6 | 10 | 1703.2 | 10.3 |
| | 16 | 2 | 223 | 38.2 | 7.3 | 10 | 2168.0 | 12.3 |
| | | 4 | 233 | 47.8 | 6.8 | 10 | 2654.3 | 15.4 |
| | 16 | 1 | 224 | 37.5 | 6.4 | 10 | 2098.7 | 12.1 |
| | | 3 | 245 | 56.5 | 6.7 | 10 | 3136.7 | 18.2 |
| | | 5 | 230 | 54.4 | 8.0 | 10 | 2626.6 | 17.5 |
| | 16 | 2 | 235 | 51.4 | 6.0 | 10 | 2995.0 | 16.6 |
| | | 4 | 230 | 51.9 | 8.1 | 10 | 1529.2 | 16.7 |

As shown in Table 8 below a wood fibre board was formed as a sandwich of layers of course and fine wood fibres, being a fine mix that sandwiches a course mix. No water was added to the binder. The core was heated to 180° C. The waste HDPE was in the form of a colloid. The LLDPE was in the form of a powder.

TABLE 8
Wood fibre board using 12% HDPE and LDPE as binder

| | | | Processing parameters | | | |
|---|---|---|---|---|---|---|
| | | | | Board | Dimensions | |
| | | | Curing | thickness | (mm) | Weight |
| | | (g) | (min) | (mm) | (L × W) | (g) |
| 12% | Course mix (60%) | | 20 | 15 | 350 × 300 | 1800 |
| | binder (HDPE) | 86.4 | | | | |
| | binder (LDPE) | 57.6 | | | | |
| | cross linker | 6 | | | | |
| | course wood fibre | 1200 | | | | |
| | Fine mix (40%) | | | | | |
| | binder (HDPE) | 57.6 | | | | |
| | binder (LDPE) | 38.4 | | | | |
| | cross linker | 4 | | | | |
| | fine wood fibre | 800 | | | | |
| 12% | Course mix (60%) | | 10 | 16 | 350 × 300 | 1950 |
| | binder (HDPE) | 86.4 | | | | |
| | binder (LDPE) | 57.6 | | | | |
| | cross linker | 6 | | | | |
| | course wood fibre | 1200 | | | | |
| | Fine mix (40%) | | | | | |
| | binder (HDPE) | 57.6 | | | | |
| | binder (LDPE) | 38.4 | | | | |
| | cross linker | 4 | | | | |
| | fine wood fibre | 800 | | | | |

The above boards were cut into five 50 mm strips being with the first three strips front analysed for MoE and MOR and the remaining three strips rear analysed for MoE and MoR. The strips are labelled 1 to 5, with 1 being the left most strip of the board, 3 being the central strips, and 5 being the right most strip. Each of the strips measured 300 mm×50 mm.

TABLE 9
Strength testing the boards of Table 8.

| | | | | | Deflec- | | | |
|---|---|---|---|---|---|---|---|---|
| | | | | | tion @ | Speed | | |
| | Binder | | Wt | Fmax | Fmax | (mm/ | Em | fm |
| | (%) | | (g) | (N) | (mm) | min) | (MoE) | (MoR) |
| Front | 12 | 1 | 184 | 34.0 | 7.6 | 10 | 2133.8 | 12.4 |
| | | 3 | 221 | 52.2 | 7.3 | 10 | 3462.6 | 19.1 |
| | | 5 | 198 | 40.2 | 8.1 | 10 | 2454.7 | 14.7 |
| | 12 | 1 | 231 | 59.8 | 7.4 | 10 | 2998.8 | 19.3 |
| | | 3 | 239 | 61.9 | 6.8 | 10 | 3511.4 | 19.9 |
| | | 4 | 225 | 47.5 | 7.3 | 10 | 2396.8 | 15.3 |

### Example 2—5-Ply Plywood

Each ply-layer has 12 to 15 g of Kezadol GR powder put on sheet before being sprayed with the binder. Kezadol GR works as a moisture absorbant

Each sheet of ply was placed at alternate horizontal and vertical.

Used waste HDPE.

TABLE 10
Plywood board 12% and 20% liquidised HDPE as binder

| | | | | Processing parameters | | | | |
|---|---|---|---|---|---|---|---|---|
| | | | | Core | | Board | Dimensions | |
| Binder | | | | Temp | Curing | thickness | (mm) | Weight |
| (%) | | | | (° C.) | (min) | (mm) | (L × W) | (g) |
| 12 | 100% HDPE | 160 | g | 140 | 90 | 17 | 270 × 270 | 485 |
| | Cross linker | 10 | g | | | | | |
| 20 | 100% HDPE | 160 | g | 140 | 80-90 | 17 | 270 × 250 | 1.042 |
| | Cross linker | 10 | g | | | | | |

We claim:

1. A method for manufacturing a composite panel comprising
a) introducing a composite mixture into a press or mould, the composite mixture comprising
about 4% to about 30% by weight of a binder that comprises particularised plastic having a particle size of less than 4 mm, and
about 70 to about 96% by weight of a plurality of substrate,
about 0.1 to about 3% by weight of the binder of a crosslinking agent,
b) subjecting the composite mixture to pressure of about 3 MPa to about 10 MPa and heating the composite mixture to about 100° C. to about 220° C. to form the composite panel.

2. A method of claim 1 wherein the substrate comprises a fine mixture and a coarse mixture at a ratio of about 20:80 to about 80:20,
the fine mixture comprising a fibrous or particulate substrate having an average particle size of about 0.25 mm to about 2 mm, and
the coarse mixture comprising a fibrous or particulate substrate having a particle size of about 1 mm to about 15 mm.

3. A method of claim 1 wherein the substrate is in the form of a plurality of sheets and the binder is layered between each sheet.

4. A method of any one of claims 1 to 3 wherein the binder is in the form of a powder admixed with the substrate.

5. A method of any one of claims 1 to 3 wherein the binder is in the form of a water based slurry.

6. A method of any one of claims 1 to 5 wherein the binder comprises a low-melt plastic having a melting point of 130° C. or less and a particle size of less than about 4 mm.

7. A method of claim 6 wherein the binder comprises a high-melt plastic having a melting point greater than 130° C. and a particle size of greater than about 4 mm.

8. A method of claim 7 wherein the high melt plastic comprises ABS or acrylic, or a combination thereof.

9. A method of any one of claims 1 to 5 wherein the plastic source is selected from dissolvable and high-melt plastics, the dissolvable plastic comprising about 15% to about 85% by weight of the total amount of plastic substrate of PET, PVC, PC or a combination thereof, and the high-melt plastic being a slurry of plastic particles, having a particle size of less than about 2 mm, selected from acrylics, EVA, PVC, ABS, PE or a combination thereof.

10. A method of any one of claims 1 to 9 wherein the composite board has one or more of the following characteristics:
a) an MOE of about 1,000 to 4000 MPa,
b) an MOR of about 5 to about 25 MPa,
c) a surface screw holding of about 200 to about 500 N,
d) any combination of (a) to (c)

11. A method of any one of claims 1 to 10 wherein the plastic has a particle size of less than 2 mm.

12. A method of any one of claims 1 to 11 wherein the plastic particles have a sphericity of about 0.04 to about 0.3 v.

13. A method of any one of claims 1 to 12 wherein the plastic is selected from a polyethylene, polyvinyl chloride, polyethylene terephthalate or a polypropylene, or a combination thereof.

14. A method of any one of claims 1 to 13 wherein the plastic is a combination of a high density polyethylene (HDPE) and a low density polyethylene (LDPE).

15. A method of claim 14 wherein the ratio of HDPE to LDPE is about 20:80 to about 80:20.

16. A method of any one of claims 1 to 15 wherein the binder comprises 20, 30, 40, 50, 60, 70, or 80% solids content.

17. A method of any one of claims 1 to 16 wherein the cross linker is a peroxide based cross-linker.

18. A method of any one of claims 1, 2 or 4 to 17 wherein the substrate is selected from wood fibre, coconut husk, wood dust, sawdust, cellulosic material, chipped rubber or a combination thereof.

19. A method of claim 18 wherein the substrate is a wood substrate having a particle size of less than 15 mm.

20. A method of any one of claims 1 to 19 wherein the substrate has a moisture content of less than 10%, less than 8%, or less than 6% by weight.

21. A method of any one of claims 1 to 20 wherein the composite product is a wood-based composite panel and comprises a combination of fine and course wood fibre.

22. A method of claim 21 wherein the panel comprises about 20:80 to about 80:20 of fine to course fibre.

23. A method of any one of claims 1 to 22 wherein the binder is incrementally mixed with the fibrous or particulate substrate.

24. A method of claim 3 wherein the substrate is in the form of a sheet of wood.

25. A method of any one of claims 1 to 24 wherein the plastic source and substrate are placed into a mould to form a desired product end shape.

26. A method of any one of claims 1 to 25 wherein the composite product is a wood-based composite panel such as plywood, particle board, or medium density board.
